(19) United States
(12) Patent Application Publication
(10) Pub. No.: US 2020/0278772 A1
(43) Pub. Date: Sep. 3, 2020

(54) TRANSFER MATERIAL, TOUCH SENSOR, METHOD FOR MANUFACTURING TOUCH SENSOR, AND IMAGE DISPLAY DEVICE

(71) Applicant: FUJIFILM Corporation, Tokyo (JP)

(72) Inventors: Kentaro TOYOOKA, Fujinomiya-shi (JP); Yohei ARITOSHI, Fujinomiya-shi (JP); Hideyuki NAKAMURA, Fujinomiya-shi (JP); Hidenori GOTO, Fujinomiya-shi (JP)

(73) Assignee: FUJIFILM Corporation, Tokyo (JP)

(21) Appl. No.: 16/845,245

(22) Filed: Apr. 10, 2020

Related U.S. Application Data
(63) Continuation of application No. PCT/JP2018/032113, filed on Aug. 30, 2018.

(30) Foreign Application Priority Data
Oct. 16, 2017 (JP) 2017200558

(51) Int. Cl. G06F 3/044; B32B 7/025; B32B 7/06; B32B 27/36; B32B 27/08; B32B 37/00

(52) U.S. Cl. CPC G06F 3/0445; B32B 7/025; B32B 7/06; B32B 27/36; B32B 2367/00; B32B 37/025; G06F 2203/04103; B32B 2457/208; B32B 27/08

(57) ABSTRACT

A transfer material includes a temporary support; a second transparent transfer layer; a third transparent transfer layer that is disposed on one surface of the second transparent transfer layer between the temporary support and the second transparent transfer layer and has a refractive index higher than a refractive index of the second transparent transfer layer; and a first transparent transfer layer that is disposed on the other surface of the second transparent transfer layer and has a refractive index higher than the refractive index of the second transparent transfer layer.

### CROSS-REFERENCE TO RELATED APPLICATIONS

This application is a Continuation of PCT International Application No. PCT/JP2018/032113 filed on Aug. 30, 2018, which claims priority under 35 U.S.C. § 119(a) to Japanese Patent Application No. 2017-200558 filed on Oct. 16, 2017. Each of the above application(s) is hereby expressly incorporated by reference, in its entirety, into the present application.

### BACKGROUND OF THE INVENTION

### 1. Field of the Invention

The present disclosure relates to a transfer material, a touch sensor, a method for manufacturing a touch sensor, and an image display device.

### 2. Description of the Related Art

In the related art, techniques for making an internal structure (for example, an electrode or the like) difficult to be recognized externally so as not to impair the appearance and a displayed image while imparting functionality have been examined in electronic devices such as a mobile phone, a car navigation system, a personal computer, a ticket vending machine, and a bank terminal.

In recent years, for example, input devices in which information corresponding to command images can be input by touching the command images with a finger, a stylus, or the like (hereinafter, also referred to as touch panels) have been broadly used. As the touch panels, there are resistance film-type devices and electrostatic capacitance-type devices. Electrostatic capacitance-type touch panels have an advantage of being capable of having a simple structure in which a translucent conductive film is formed on a single substrate.

As an example of the electrostatic capacitance-type touch panels, a device in which electrode patterns are respectively extended in mutually intersecting directions and a touch location is detected by sensing a change in electrostatic capacitance caused by a conductor such as a human finger approaching the electrode patterns is known (for example, refer to JP2013-206197A).

In addition, as a technique related to covering properties of the electrode pattern, there is a disclosure regarding a transparent laminate including a first curable transparent resin layer; and a second curable transparent resin layer that is disposed adjacent to the first curable transparent resin layer and has a refractive index of 1.6 or more which is higher than a refractive index of the first curable transparent resin layer (for example, refer to JP2014-108541A).

There is also a disclosure regarding a transparent touch switch in which a transparent conductive film, an adhesive layer having a thickness of 25 μm or more, and an overcoat layer having a refractive index higher than a refractive index of the adhesive layer is laminated, and which has a gradually decreasing refractive index (for example, refer to WO2006/126604A).

### SUMMARY OF THE INVENTION

At the time of using the electrostatic capacitance-type touch panel, in a case where the surface of the touch panel is observed from, for example, a location slightly away from a location at which light incident from an internal light source is normally reflected, there is a case where the electrode patterns present inside the panel become visible and the appearance is impaired. Therefore, as performance for touch panels, a favorable electrode-pattern-covering property is demanded.

It is considered difficult to visually recognize wiring and electrode patterns in a touch sensor, in which an electrode extending in one direction (for example, an X direction) and an electrode extending in another direction (for example, a Y direction) via a transparent layer are disposed on one side of a base material, as compared to a bridge-type touch sensor including bridge wires that build bridges between electrodes.

However, it is difficult to say that a sufficient covering property is always ensured for electrode patterns, and therefore further amelioration of visibility of patterns is required.

The present disclosure has been made in consideration of the above circumstances. That is, an object of one embodiment of the present invention is to provide a transfer material having an excellent cover-target-covering property and ameliorated visibility of a cover target.

Another object of one embodiment of the present invention is to provide a touch sensor having an excellent electrode-pattern-covering property and ameliorated visibility of electrode patterns.

Still another object of one embodiment of the present invention is to provide a method for manufacturing a touch sensor having an excellent electrode-pattern-covering property and ameliorated visibility of electrode patterns.

Still another object of one embodiment of the present invention is to provide an image display device having ameliorated visibility of electrode patterns.

As specific means for achieving the above-described objects, the following aspects are included.

<1> A transfer material comprising: a temporary support; a second transparent transfer layer; a third transparent transfer layer that is disposed on one surface of the second transparent transfer layer between the temporary support and the second transparent transfer layer and has a refractive index higher than a refractive index of the second transparent transfer layer; and a first transparent transfer layer that is disposed on the other surface of the second transparent transfer layer and has a refractive index higher than the refractive index of the second transparent transfer layer.

<2> The transfer material according to <1>, in which a thickness of the second transparent transfer layer is 0.5 μm or more, and a thickness of each of the first transparent transfer layer and the third transparent transfer layer is 0.3 μm or less.

<3> The transfer material according to <1> or <2>, in which a refractive index of each of the first transparent transfer layer and the third transparent transfer layer is 1.6 or more.

<4> The transfer material according to any one of <1> to <3>, in which the first transparent transfer layer and the third transparent transfer layer contain a metal oxide particle.

<5> The transfer material according to any one of <1> to <4>, the transfer material further comprising: a fourth transparent transfer layer that is disposed on a side of the first transparent transfer layer opposite to the surface on which the second transparent transfer layer is disposed, and has a refractive index lower than the refractive index of the first transparent transfer layer, and a fifth transparent transfer layer that is disposed on a side of the third transparent transfer layer opposite to the surface on which the second transparent transfer layer is disposed, and has a refractive index lower than the refractive index of the third transparent transfer layer.

<6> A touch sensor comprising: a substrate that has a base material and a patterned first electrode; a patterned second electrode; a second transparent layer that is disposed between the first electrode and the second electrode and has a thickness of 0.5 μm or more and less than 25 μm; a first transparent layer that is disposed between the first electrode and the second transparent layer and has a refractive index higher than a refractive index of the second transparent layer; and a third transparent layer that is disposed between the second electrode and the second transparent layer and has a refractive index higher than a refractive index of the second transparent layer.

<7> The touch sensor according to <6>, in which a thickness of the second transparent layer is 0.5 μm or more, and a thickness of each of the first transparent layer and the third transparent layer is 0.3 μm or less.

<8> The touch sensor according to <6> or <7>, in which a refractive index of each of the first transparent layer and the third transparent layer is 1.6 or more.

<9> The touch sensor according to any one of <6> to <8>, in which the first transparent layer and the third transparent layer contain a metal oxide particle.

<10> The touch sensor according to any one of claims 6 to 9, the touch sensor further comprising: a fourth transparent layer that is disposed on a side of the first transparent layer opposite to the side on which the second transparent layer is disposed, and has a refractive index lower than the refractive index of the first transparent layer; and a fifth transparent layer that is disposed on a side of the third transparent layer opposite to the side on which the second transparent layer is disposed, and has a refractive index lower than the refractive index of the third transparent layer.

<11> The touch sensor according to <10>, in which the first transparent layer, the second transparent layer, the third transparent layer, the fourth transparent layer, and the fifth transparent layer are transfer layers.

<12> The touch sensor according to any one of <6> to <11>, the touch sensor further comprising a sixth transparent layer that is disposed between the base material and the first electrode and has a refractive index which is higher than a refractive index of the base material and is lower than a refractive index of the first electrode.

<13> The touch sensor according to any one of <6> to <12>, the touch sensor further comprising a seventh transparent layer that is disposed on a side of the second electrode opposite to the side on which the second transparent layer is disposed, and has a refractive index lower than a refractive index of the second electrode.

<14> A method for manufacturing a touch sensor by using the transfer material according to any one of <1> to <5>, the method comprising:

transferring the transfer material to form a second transparent layer on a first electrode;

transferring the transfer material between the first electrode and the second transparent layer to form a first transparent layer having a refractive index higher than a refractive index of the second transparent layer;

transferring the transfer material on a side of the second transparent layer opposite to the side having the first transparent layer to form a third transparent layer having a refractive index higher than the refractive index of the second transparent layer; and

disposing a second electrode on a side of the third transparent layer opposite to the side having the second transparent layer.

<15> The method for manufacturing a touch sensor according to <14>, the method further comprising: transferring the transfer material on a side of the first transparent layer opposite to a side in contact with the second transparent layer to form a fourth transparent layer having a refractive index lower than the refractive index of the first transparent layer; and transferring the transfer material on a side of the third transparent layer opposite to a side in contact with the second transparent layer to form a fifth transparent layer having a refractive index lower than a refractive index of the third transparent layer.

<16> An image display device comprising the touch sensor according to any one of <6> to <13>.

According to one embodiment of the present invention, a transfer material having an excellent cover-target-covering property and ameliorated visibility of a cover target is provided.

According to another embodiment of the present invention, a touch sensor having an excellent electrode-pattern-covering property and ameliorated visibility of electrode patterns is provided.

According to still another embodiment of the present invention, a method for manufacturing a touch sensor having an excellent electrode-pattern-covering property and ameliorated visibility of electrode patterns is provided.

According to still another embodiment of the present invention, an image display device having ameliorated visibility of electrode patterns is provided.

### BRIEF DESCRIPTION OF THE DRAWINGS

FIG. 1 is a schematic cross-sectional view showing one embodiment of a transfer material of the present disclosure.

FIG. 2 is a schematic cross-sectional view showing another embodiment of a transfer material of the present disclosure.

FIG. 3 is a schematic cross-sectional view showing a first embodiment of a touch sensor according to the present disclosure.

FIG. 4 is a schematic cross-sectional view showing a second embodiment of a touch sensor according to the present disclosure.

FIG. 5 is a schematic cross-sectional view showing a third embodiment of a touch sensor according to the present disclosure.

FIG. 6 is a schematic cross-sectional view showing a fourth embodiment of a touch sensor according to the present disclosure.

### DESCRIPTION OF THE PREFERRED EMBODIMENTS

In the present specification, a numerical range expressed using “to” indicates a range including numerical values before and after “to” as the minimum value and the maximum value respectively. In numerical ranges expressed stepwise in the present disclosure, the upper limit value or the lower limit value described in a certain numerical range may be substituted into the upper limit value or the lower limit value of a different numerical range expressed stepwise. In addition, in numerical ranges expressed in the present disclosure, the upper limit value or the lower limit value described in a certain numerical range may be substituted into a value described in an example.

In the present specification, in a case where there is a plurality of substances corresponding to a certain component in a composition, unless particularly otherwise described, the amount of the component in the composition refers to the total amount of the plurality of substances present in the composition.

In addition, the term “step” in the present specification refers not only to an independent step but also a step that cannot be clearly differentiated from other steps as long as the intended purpose of the step is achieved.

In the present specification, “being transparent” means that the average transmittance of visible light having a wavelength of 400 nm to 700 nm is 80% or more. Therefore, for example, a “transparent layer,” a “transparent transfer layer,” and the like refer to a layer having an average transmittance of visible light having a wavelength of 400 nm to 700 nm being 80% or more. The average transmittance of visible light of the “transparent layer,” the “transparent transfer layer,” and the like is preferably 90% or more.

In addition, the average transmittance of the “transparent layer,” the “transparent transfer layer,” and the like is a value measured at 25° C. using a spectrophotometer and can be measured using, for example, a spectrophotometer U-3310 manufactured by Hitachi, Ltd.

In the present specification, unless particularly otherwise described, the content ratio of each constitutional unit of a polymer is a molar ratio.

In addition, in the present specification, the refractive index is a value measured using an ellipsometry at a wavelength of 550 nm and at 25° C. unless particularly otherwise described.

Hereinafter, a transfer material, a touch sensor, a method for manufacturing a touch sensor, and an image display device of the present disclosure will be described in detail.

A transfer material of the present disclosure includes a temporary support; a second transparent transfer layer; a third transparent transfer layer that is disposed on one surface of the second transparent transfer layer between the temporary support and the second transparent transfer layer and has a refractive index higher than a refractive index of the second transparent transfer layer; and a first transparent transfer layer that is disposed on the other surface (a surface on which the third transparent transfer layer is not disposed among the two surfaces of the second transparent transfer layer) of the second transparent transfer layer and has a refractive index higher than the refractive index of the second transparent transfer layer. The transfer material includes the temporary support, the third transparent transfer layer, the second transparent transfer layer, and the first transparent transfer layer in this order.

The transfer material of the present disclosure may be in any form of a film or a sheet.

In the related art, techniques for making an internal structure, which needs to be covered (for example, an electrode), difficult to be recognized externally and for maintaining favorable appearance and a displayed image while imparting functionality have been examined in various kinds of electronic devices. For example, in the field of touch sensors, there has been a problem of electrode patterns being easily visually recognized from the outside during use in a case where the touch sensor has a structure in which an electrode extending in one direction and an electrode extending in the other direction are disposed via a transparent layer.

Among the above-mentioned techniques in the related art, for example, JP2014-108541A proposes the structure in which the second curable transparent resin layer having a refractive index higher than a refractive index of the first curable transparent resin layer is disposed on one side of the first curable transparent resin layer, as a technique for avoiding visibility of electrode patterns. However, in this technique, it is necessary to install a bridge wire or to install an insulating layer between sensor electrodes.

In addition, WO2006/126604A discloses the structure in which the overcoat layer is laminated on a thick adhesive layer having a thickness of 25 μm or more. However, the technique described in WO2006/126604A has a problem of the laminate being thick.

In view of the above circumstances, as described above, the transfer material of the present disclosure has a laminate structure in which the second transparent transfer layer, and the first transparent transfer layer and the third transparent transfer layer which have a refractive index higher than a refractive index of the second transparent transfer layer and which are disposed so as to sandwich the second transparent transfer layer therebetween, are disposed to overlap, and thereby it is possible to obtain a covering effect on a structure (for example, an electrode) showing a high refractive index by incorporating a metal therein, and to effectively ameliorate visibility of the structure.

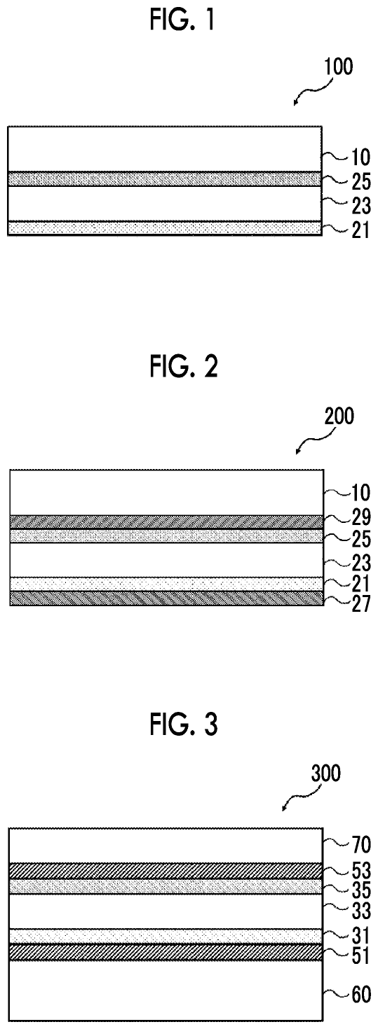

For example, as shown in FIG. 1, the transfer material of the present disclosure includes a temporary support 10, a second transparent transfer layer 23, a third transparent transfer layer 25 disposed on one surface of the second transparent transfer layer 23 between the temporary support 10 and the second transparent transfer layer 23, and a first transparent transfer layer 21 disposed on the other surface of the second transparent transfer layer 23.

(Temporary Support)

A material of the temporary support is not particularly limited as long as the material has a strength and flexibility necessary for the formation of a film. A resin film is preferred from the viewpoint of formability and costs.

A film that is used as the temporary support is preferably a flexible film that does not significantly deform, shrink, or stretch under pressurization or under pressurization and heating. More specifically, as the temporary support, a polyethylene terephthalate (PET) film, a triacetyl cellulose (TAC) film, a polystyrene (PS) film, a polycarbonate (PC) film, and the like are exemplified, and a biaxially stretched polyethylene terephthalate film is preferred.

The appearance of the temporary support is also not particularly limited, and the temporary support may be a transparent film or a colored film. As the colored film, resin films containing a silicon dye, an alumina sol, a chromium salt, a zirconium salt, or the like are exemplified.

To the temporary support, it is possible to impart a conductive property using a method described in JP2005-221726A or the like.

Hereinafter, regarding the transparent layers on the temporary support, the first transparent transfer layer, the second transparent transfer layer and third transparent transfer layer, and the fourth transparent transfer layer and fifth transparent transfer layer will be described in detail.

In a case where a touch sensor of the present disclosure is formed by a transfer method using a transfer material, a layer formed by transferring the first transparent transfer layer is a first transparent layer, and a layer formed by transferring the second transparent transfer layer is a second transparent layer, and a layer formed by transferring the third transparent transfer layer is a third transparent layer. In addition, a layer formed by transferring the fourth transparent transfer layer is a fourth transparent layer, and a layer formed by transferring the fifth transparent transfer layer is a fifth transparent layer.

First, the second transparent transfer layer will be described in detail.

(Second Transparent Transfer Layer)

On the temporary support, the transfer material of the present disclosure has a second transparent transfer layer between a first transparent transfer layer and a third transparent transfer layer to be described later. In a case where a touch sensor is produced as described later, the second transparent transfer layer can form the second transparent layer after transfer.

The second transparent transfer layer may be, for example, a layer including at least a polymerizable monomer and a resin or may be a layer that is cured by imparting energy. The second transparent transfer layer may further include a polymerization initiator and a compound capable of reacting with an acid by heating.

The second transparent transfer layer may be light-curable, heat-curable, or heat-curable and light-curable. Particularly, the second transparent transfer layer is preferably a heat-curable and light-curable composition since it is possible to further improve the reliability of the film.

That is, the second transparent layer may be formed as described below.

The second transparent transfer layer is transferred to a transfer target by a transfer method using the transfer material having the second transparent transfer layer on the temporary support. The transferred second transparent transfer layer is patterned by being irradiated with light. A treatment such as developing or the like is carried out on the patterned second transparent transfer layer.

It is preferable that the second transparent transfer layer in the present disclosure is an alkali-soluble resin layer and can be developed by a weak alkali aqueous solution.

The refractive index and thickness of the second transparent transfer layer are the same as those of the second transparent layer to be described later.

The second transparent transfer layer is not particularly limited as long as it is a transparent layer having a refractive index lower than a refractive index of the first transparent transfer layer and the third transparent transfer layer, and can be appropriately selected depending on the purpose. A refractive index of the second transparent transfer layer is preferably 1.4 to 1.6, more preferably 1.4 to 1.55, and still more preferably 1.45 to 1.55.

The thickness of the second transparent transfer layer is not particularly limited and can be appropriately selected depending on the purpose. A thickness of the second transparent transfer layer is preferably 0.5 μm (500 nm) or more, more preferably 0.5 μm or more and less than 30 μm, and still more preferably 0.5 μm or more and less than 25 μm. In addition, in a case where the transfer material of the present disclosure is applied to, for example, a touch sensor that is an electrostatic capacitance-type input device, a thickness of the second transparent transfer layer is preferably 1 μm to 25 μm, and particularly preferably 1 μm to 10 μm from the viewpoint of transparency.

The second transparent transfer layer may be formed of a negative-type material including a polymerizable monomer. In this case, the second transparent transfer layer becomes excellent in terms of strength and reliability.

—Resin—

The second transparent transfer layer is capable of containing at least one kind of resin. The resin is capable of functioning as a binder. The resin included in the second transparent transfer layer is preferably an alkali-soluble resin.

The term “alkali-soluble” means being soluble in a 1 mol/l sodium hydroxide solution at 25° C.

The alkali-soluble resin is preferably, for example, a resin having an acid value of 60 mgKOH/g or more from the viewpoint of developability. In addition, a resin having a carboxyl group is preferred since the resin reacts with a crosslinking component to thermally cross-link and is likely to form a strong film.

The alkali-soluble resin is preferably an acrylic resin from the viewpoint of developability and transparency. The acrylic resin refers to a resin having a constitutional unit derived from at least one kind of (meth)acrylic acid or (meth)acrylic acid ester.

The acid value of the alkali-soluble resin is not particularly limited, but a carboxyl group-containing acrylic resin having an acid value of 60 mgKOH/g or more is preferred.

The carboxyl group-containing acrylic resin having an acid value of 60 mgKOH/g or more is not particularly limited as long as the condition of the acid value is satisfied, and a resin appropriately selected from well-known resins can be used. For example, among the polymers described in Paragraph 0025 of JP2011-095716A, the carboxyl group-containing acrylic resin having an acid value of 60 mgKOH/g or more, among the polymers described in Paragraphs 0033 to 0052 of JP2010-237589A, the carboxyl group-containing acrylic resin having an acid value of 60 mgKOH/g or more, and the like are exemplified.

A preferred range of the copolymerization ratio of a monomer having a carboxyl group in the alkali-soluble resin is 5% by mass to 50% by mass, more preferably 5% by mass to 40% by mass, and still more preferably in a range of 20% by mass to 30% by mass with respect to 100% by mass of the alkali-soluble resin.

As the alkali-soluble resin, polymers shown below are preferred. The content ratio of each constitutional unit shown below can be appropriately changed depending on the purpose.

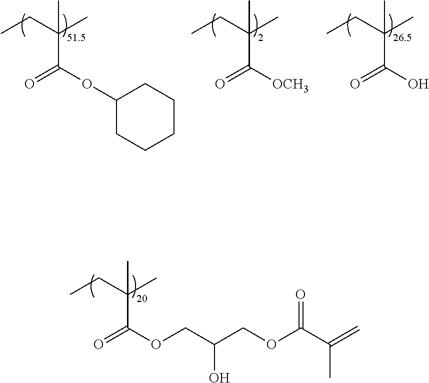

Specifically, the acid value of the alkali-soluble resin is preferably 60 mgKOH/g to 200 mgKOH/g, more preferably 60 mgKOH/g to 150 mgKOH/g, and still more preferably 60 mgKOH/g to 110 mgKOH/g.

In the present specification, the acid value of the resin is a value measured using a titration method regulated in JIS K0070 (1992).

In a case where both the second transparent transfer layer and the first transparent transfer layer described below contain the acrylic resin, it is possible to enhance the interlayer adhesiveness between the second transparent transfer layer and the first transparent transfer layer.

The weight-average molecular weight of the alkali-soluble resin is preferably 5,000 or more and more preferably 10,000 or more. The upper limit value of the weight-average molecular weight of the alkali-soluble resin is not particularly limited and may be set to 100,000.

The term weight-average molecular weight refers to a value measured by gel permeation chromatography (GPC). The same applies below.

The measurement by GPC uses HLC (registered trademark)-8020GPC (TOSOH CORPORATION) as a measuring device, three TSKgel (registered trademark) Super Multipore HZ-H (4.6 mm ID×15 cm, TOSOH CORPORATION) as columns, and tetrahydrofuran as an eluent. In addition, the measurement is performed using a differential refractive index (RI) detector with a specimen concentration of 0.45% by mass, a flow rate of 0.35 mL/min, a sample injection amount of 10 μL, and a measurement temperature of 40° C.

A calibration curve is produced from “standard specimen TSK standard, polystyrene” manufactured by Tosoh Corporation: eight samples of “F-40,” “F-20,” “F-4,” “F-1,” “A-5000,” “A-2500,” “A-1000,” and “n-propylbenzene.”

From the viewpoint of the handleability of the second transparent transfer layer to be cured and the hardness of the cured film, the content of the resin is preferably in a range of 10% by mass to 80% by mass and more preferably in a range of 40% by mass to 60% by mass with respect to the total mass of the second transparent transfer layer. In a case where the content of the resin is 80% by mass or less, the amount of the monomer does not become too small, the crosslink density of a cured film is favorably maintained, and the second transparent transfer layer becomes excellent in terms of hardness. In addition, in a case where the content of the resin is 10% by mass or more, the film to be cured does not become too soft, and there is an advantage in handleability in the film.

—Polymerizable Monomer—

The second transparent transfer layer in the present disclosure may contain a polymerizable monomer.

As the polymerizable monomer, the second transparent transfer layer preferably includes a polymerizable monomer having an ethylenic unsaturated group and more preferably includes a photopolymerizable compound having an ethylenic unsaturated group. The polymerizable monomer preferably has at least one ethylenic unsaturated group as a photopolymerizable group and may have a cationic polymerizable group such as an epoxy group in addition to the ethylenic unsaturated group. The polymerizable monomer included in the second transparent transfer layer is preferably a compound having a (meth)acryloyl group.

The second transparent transfer layer preferably includes, as the polymerizable monomer, a compound having two ethylenic unsaturated groups and a compound having at least three ethylenic unsaturated groups and more preferably includes a compound having two (meth)acryloyl groups and a compound having at least three (meth)acryloyl groups.

In addition, at least one kind of the polymerizable monomer preferably contains a carboxyl group since a carboxyl group in the resin and the carboxyl group in the polymerizable monomer form a carboxyl acid anhydride, thereby enhancing moisture-heat resistance.

The polymerizable monomer containing a carboxyl group is not particularly limited, and commercially available compounds can be used. As commercially available products, for example, ARONIX TO-2349 (manufactured by Toagosei Co., Ltd.), ARONIX M-520 (manufactured by Toagosei Co., Ltd.), ARONIX M-510 (manufactured by Toagosei Co., Ltd.), and the like are preferably exemplified. In a case where the second transparent transfer layer includes the polymerizable monomer containing a carboxyl group, the content of the polymerizable monomer containing a carboxyl group used is preferably in a range of 1% by mass to 50% by mass, more preferably in a range of 1% by mass to 30% by mass, and still more preferably in a range of 5% by mass to 15% by mass of all of the polymerizable monomers included in the second transparent transfer layer.

The polymerizable monomer preferably includes a urethane (meth)acrylate compound.

In a case where the second transparent transfer layer includes the urethane (meth)acrylate compound, the content thereof is preferably 10% by mass or more and more preferably 20% by mass or more of all of the polymerizable monomers included in the second transparent transfer layer. The number of functional groups of the photopolymerizable group in the urethane (meth)acrylate compound, that is, the number of (meth)acryloyl groups is preferably three or more and more preferably four or more.

The polymerizable monomer having a bifunctional ethylenic unsaturated group is not particularly limited as long as the polymerizable monomer is a compound having two ethylenic unsaturated groups in the molecule, and it is possible to use commercially available (meth)acrylate compounds. As commercially available products, for example, tricyclodecane dimethanol diacrylate (A-DCP, manufactured by Shin-Nakamura Chemical Co., Ltd.), tricyclodecane dimethanol dimethacrylate (DCP, manufactured by Shin-Nakamura Chemical Co., Ltd.), 1,9-nonanediol diacrylate (A-NOD-N, manufactured by Shin-Nakamura Chemical Co., Ltd.), 1,6-hexanediol diacrylate (A-HD-N, manufactured by Shin-Nakamura Chemical Co., Ltd.), and the like are preferably exemplified.

A polymerizable monomer having a tri- or higher-functional ethylenic unsaturated group is not particularly limited as long as the polymerizable monomer is a compound having three or more ethylenic unsaturated groups in a molecule, and it is possible to use, for example, (meth)acrylate compounds having a skeleton such as dipentaerythritol (tri/tetra/penta/hexa)acrylate, pentaerythritol (tri/tetra)acrylate, trimethylolpropane triacrylate, ditrimethyloipropane tetraacrylate, isocyanurate acrylate, and glycerine triacrylate.

The molecular weight of the polymerizable monomer is preferably 200 to 3,000, more preferably 250 to 2,600, and particularly preferably 280 to 2,200.

Only one kind of the polymerizable monomer may be used, or two or more kinds of the polymerizable monomers may be used. Two or more kinds of the polymerizable monomers are preferably used since it is possible to control the film properties of the second transparent transfer layer.

Particularly, as the polymerizable monomer contained in the second transparent transfer layer, a combination of a tri- or higher-functional polymerizable monomer and a bifunctional polymerizable monomer is preferably used from the viewpoint of improving the film properties of the transferred second transparent transfer layer after being exposed.

In the case of using a bifunctional polymerizable monomer, the amount of the bifunctional polymerizable monomer used is preferably in a range of 10% by mass to 90% by mass, more preferably in a range of 20% by mass to 85% by mass, and still more preferably in a range of 30% by mass to 80% by mass of all of the polymerizable monomers included in the second transparent transfer layer.

In the case of using a tri- or higher-functional polymerizable monomer, the amount of the tri- or higher-functional polymerizable monomer used is preferably in a range of 10% by mass to 90% by mass, more preferably in a range of 15% by mass to 80% by mass, and still more preferably in a range of 20% by mass to 70% by mass of all of the polymerizable monomers included in the second transparent transfer layer.

To the second transparent transfer layer, it is possible to further add a variety of components depending on the purpose in addition to the resin and the polymerizable monomer.

As a random component, a polymerization initiator, a compound capable of reacting with an acid by heating, and the like are exemplified.

—Polymerization Initiator—

The second transparent transfer layer preferably includes a polymerization initiator and more preferably includes a photopolymerization initiator. In a case where the second transparent transfer layer includes the polymerization initiator in addition to the resin and the polymerizable monomer, it becomes easy to form a pattern in the second transparent transfer layer.

As the polymerization initiator, photopolymerization initiators described in Paragraphs 0031 to 0042 ofJP2011-095716A are exemplified.

As the photopolymerization initiator, for example, 1,2-octane dione, 1-[4-(phenylthio)-, 2-(O-benzoyloxime)] (trade name: IRGACURE OXE-01, manufactured by BASF), additionally, ethanone, 1-[9-ethyl-6-(2-methylbenzoyl)-9H-carbazole-3-yl]-,1-(O-acetyloxime) (trade name: IRGACURE OXE-02, manufactured by BASF), 2-benzyl-2-dimethylamino-1-(4-morpholinophenyl)butanone (trade name: Irgacure 379, manufactured by BASF), 2-(dimethylamino)-2-[(4-methylphenyl)methyl]-1-[4-(4-morpholinyl)phenyl]-1-butanone (trade name: IRGACURE 379EG, manufactured by BASF), 2-methyl-1-(4-methyl thiophenyl)-2-morpholinopropan-1-one (trade name: IRGACURE 907, manufactured by BASF), KAYACURE DETX-S (manufactured by Nippon Kayaku Co., Ltd.), and the like are preferably exemplified.

In a case where the second transparent transfer layer includes the polymerization initiator, the content of the polymerization initiator is preferably 0.01% by mass or more and more preferably 0.1% by mass or more of the solid content of the second transparent transfer layer. In addition, the content of the polymerization initiator is preferably 10% by mass or less and more preferably 5% by mass or less. In a case where the content of the polymerization initiator is in the above-described range, it is possible to further improve pattern formability in the transfer material and adhesiveness to transfer targets.

The second transparent transfer layer in the present disclosure is capable of further including at least one selected from a sensitizer or a polymerization inhibitor in order to adjust the curing sensitivity.

—Sensitizer—

The second transparent transfer layer in the present disclosure is capable of including a sensitizer.

The sensitizer has an action of further improving the sensitivity of a sensitizing dye, the polymerization initiator, or the like included in the second transparent transfer layer with respect to active radioactive rays, an action of suppressing the polymerization inhibition of the polymerizable compound by oxygen, or the like.

As an example of the sensitizer in the present disclosure, thiol and sulfide compounds, for example, thiol compounds described in JP1978-000702A (JP-S53-000702A), JP1980-500806B (JP-S55-500806B), and JP1993-142772A (JP-H5-142772A), disulfide compounds of JP1981-075643A (JP-S56-075643A), and the like are exemplified. More specifically, 2-mercaptobenzothiazole, 2-mercaptobenzoxazole, 2-mercaptobenzimidazole, 2-mercapto-4 (3H)-quinazoline, β-mercaptonaphthalene, and the like are exemplified.

As another example of the sensitizer in the present disclosure, amino acid compounds such as N-phenylglycine, organic metal compounds (for example, tributyl tin acetate and the like) described in JP1973-042965B (JP-S48-042965B), hydrogen donors described in JP1980-034414B (JP-S55-034414B), sulfur compounds (for example, trithianes and the like) described in JP1994-308727A (JP-H6-308727A), and the like are exemplified.

In a case where the second transparent transfer layer in the present disclosure includes the sensitizer, the content of the sensitizer is preferably in a range of 0.01% by mass to 30% by mass and more preferably in a range of 0.05% by mass to 10% by mass of the total solid content amount of the second transparent transfer layer from the viewpoint of further improving the curing rate due to the balance between the polymerization growth rate and the chain transfer.

In a case where the second transparent transfer layer in the present disclosure includes the sensitizer, the second transparent transfer layer may include only one kind of sensitizer or may include two or more kinds of sensitizers.

—Polymerization Inhibitor—

The second transparent transfer layer in the present disclosure is capable of including a polymerization inhibitor.

The polymerization inhibitor has a function of inhibiting the undesired polymerization of the polymerizable monomer while being produced or stored.

The polymerization inhibitor in the present disclosure is not particularly limited, and it is possible to use a well-known polymerization inhibitor depending on the purpose. As the well-known polymerization inhibitor, for example, hydroquinone, p-methoxyphenol, di-t-butyl-p-cresol, pyrogallol, t-butyl catechol, benzoquinone, 4,4′-thiobis(3-methyl-6-t-butylphenol), 2,2′-methylene bis(4-methyl-6-t-butylphenol), N-nitrosophenylhydroxyamine cerous salt, phenothiazine, phenoxazine, and the like are exemplified.

In a case where the second transparent transfer layer in the present disclosure includes the polymerization inhibitor, the amount of the polymerization inhibitor added is preferably 0.01% by mass to 20% by mass of the total solid content of the second transparent transfer layer.

In a case where the second transparent transfer layer in the present disclosure includes the polymerization inhibitor, only one kind of the polymerization inhibitor may be included or two or more kinds of the polymerization inhibitors may be included.

—Compound Capable of Reacting with Acid by Heating—

The second transparent transfer layer in the present disclosure may contain a compound capable of reacting with an acid by heating.

The compound capable of reacting with an acid by heating is preferably a compound having a higher reactivity with an acid after being heated at higher than 25° C. compared with the reactivity with an acid at 25° C. The compound capable of reacting with an acid by heating is preferably a compound which has a group capable of reacting with an acid that is temporarily inactivated by a blocking agent and from which a group derived from the blocking agent is dissociated at a predetermined dissociation temperature.

As the compound capable of reacting with an acid by heating, a carboxylic acid compound, an alcohol compound, an amine compound, a blocked isocyanate compound, an epoxy compound, and the like can be exemplified, and a blocked isocyanate compound is preferred.

As the blocked isocyanate that is used for the transfer material, commercially available blocked isocyanate compounds can also be exemplified. For example, TAKENATE (registered trademark) B870N (manufactured by Mitsui Chemicals, Inc.) that is a methyl ethyl ketone oxime blocked body of isophorone diisocyanate, DURANATE (registered trademark) MF-K60B, TPA-B80E, X3071.04 (all manufactured by Asahi Kasei Corporation) that are hexamethylene diisocyanate-based blocked isocyanate compounds, AOI-BM (Showa Denko K.K.), and the like can be exemplified.

The weight-average molecular weight of the blocked isocyanate compound included in the second transparent transfer layer is preferably 200 to 3,000, more preferably 250 to 2,600, and particularly preferably 280 to 2,200.

The content of the blocked isocyanate compound is preferably in a range of 1% by mass to 30% by mass and more preferably in a range of 5% by mass to 20% by mass of the total solid content amount of the second transparent transfer layer from the viewpoint of handleability after transfer and before a heating step and low moisture permeability after the heating step.

—Particles—

The second transparent transfer layer preferably includes particles and, from the viewpoint of the refractive index and the transparency, more preferably includes metal oxide particles. In a case where the second transparent transfer layer includes particles, it is possible to adjust the refractive index and light transmittance.

The kind of the metal oxide particles is not particularly limited, and well-known metal oxide particles can be used. Specifically, metal oxide particles that can be used in the first transparent transfer layer described below can be used in the first transparent transfer layer. Particularly, from the viewpoint of suppressing the refractive index of the second transparent transfer layer to be less than 1.6, the metal oxide particles are preferably zirconium oxide particles or silicon dioxide particles and more preferably silicon dioxide particles.

—Additives—

As other additives included in the second transparent transfer layer, for example, surfactants or well-known fluorine-based surfactants described in Paragraph 0017 of JP4502784B and Paragraphs 0060 to 0071 of JP2009-237362A, thermopolymerization inhibitors described in Paragraph 0018 of JP4502784B, and other additives described in Paragraphs 0058 to 0071 of JP2000-310706A are exemplified.

As additives that are preferably used in the second transparent transfer layer, MEGAFACE (registered trademark) F551 (manufactured by DIC Corporation) which is a well-known fluorine-based surfactant is exemplified. In addition, the second transparent transfer layer preferably includes a metal oxidation suppressor.

The metal oxidation suppressor is preferably a compound having an aromatic ring including a nitrogen atom in the molecule. The aromatic ring including a nitrogen atom is preferably at least one ring selected from the group consisting of an imidazole ring, a triazole ring, a tetrazole ring, a thiadiazole ring, or a fused ring of the above-described ring and another aromatic ring, and the aromatic ring including a nitrogen atom is more preferably an imidazole ring or a fused ring of an imidazole ring and another aromatic ring. The other aromatic ring may be a homocyclic ring or a heterocyclic ring, but is preferably a homocyclic ring, more preferably a benzene ring or a naphthalene ring, and still more preferably a benzene ring.

Examples of preferred metal oxidation suppressors include imidazole, benzimidazole, tetrazole, mercapto thiadiazole, 1,2,4-triazole, and benzotriazole, and imidazole, benzimidazole, 1,2,4-triazole, and benzotriazole are more preferred. As the metal oxidation suppressor, a commercially available product may be used, and suitable examples thereof include BTI20 including benzotriazole manufactured by Johoku Chemical Co., Ltd., and the like.

The second transparent transfer layer can be formed by applying and drying a solution obtained by dissolving a resin composition for forming the second transparent transfer layer including at least the polymerizable monomer and the resin in a solvent (referred to as the coating fluid for forming the second transparent transfer layer).

The coating fluid for forming the second transparent transfer layer may contains a solvent. Examples of solvents include 1-methoxy-2-propyl acetate, methyl ethyl ketone, diacetone alcohol, ethylene glycol, propylene glycol, isobutyl alcohol, and the like.

(First Transparent Transfer Layer)

The first transparent transfer layer is disposed on the surface (the other surface) of the second transparent transfer layer which is on the side opposite to the side having the temporary support and the third transparent transfer layer to be described later, and is a transparent layer having a refractive index higher than a refractive index of the second transparent transfer layer. In a case where a touch sensor is produced as described later, the first transparent transfer layer can form the first transparent layer after transfer.

As shown in FIG. 1, the transfer material of the present disclosure may adopt, for example, an aspect in which the first transparent transfer layer 21 is disposed on the surface (the other surface) of the second transparent transfer layer 23 which is on the side opposite to the side having the temporary support 10 and the third transparent transfer layer 25 to be described later.

The first transparent transfer layer may be a layer including metal oxide particles and a resin or may be a layer that is cured by imparting energy. The first transparent transfer layer may be light-curable, heat-curable, or heat-curable and light-curable. Particularly, in a case where the first transparent transfer layer is a heat-curable and light-curable layer, it is possible to easily produce films.

In a case where the first transparent transfer layer is formed of a negative-type material, the first transparent transfer layer preferably includes, in addition to, the metal oxide particles and the resin (preferably an alkali-soluble resin), a polymerizable monomer and a polymerization initiator and may include other additives depending on the purpose.

The refractive index and thickness of the first transparent transfer layer are the same as those of the first transparent layer to be described later.

A refractive index of the first transparent transfer layer is preferably 1.6 or more, more preferably 1.6 to 1.9, and still more preferably 1.65 to 1.8.

A thickness of the first transparent transfer layer is preferably 0.5 μm or less, more preferably 0.3 μm (300 nm) or less, still more preferably 20 nm to 300 nm, further still more preferably 30 nm to 200 nm, and particularly preferably 30 nm to 100 nm.

A method for controlling the refractive index of the first transparent transfer layer is not particularly limited, and a method of singly using a transparent resin layer having a desired refractive index, a method of using a transparent resin layer to which particles such as metal particles or metal oxide particles are added, a method of using a complex of a metal salt and a polymer, and the like are exemplified.

—Resin—

The first transparent transfer layer preferably includes a resin.

The resin may have a function as a binder. As the resin, an alkali-soluble resin is preferred. The detail of the alkali-soluble resin is the same as that of the alkali-soluble resin in the second transparent transfer layer.

Among them, a resin having a constitutional unit derived from at least one kind of (meth)acrylic acid or (meth)acrylic acid ester ((meth)acrylic resin) is preferred, and a (meth)acrylic resin having a constitutional unit derived from (meth)acrylic acid and a constitutional unit derived from allyl (meth)acrylate is more preferred. In addition, in the first transparent transfer layer, ammonium salts of a resin having an acidic group can be exemplified as examples of a preferred resin.

A composition for forming the first transparent transfer layer may include the ammonium salt of a monomer having an acidic group as a curable component.

—Ammonium Salt of Resin Having Acidic Group—

The ammonium salt of a resin having an acidic group is not particularly limited, and ammonium salts of a (meth)acrylic resin are suitably exemplified.

At the time of preparing the composition for forming the first transparent transfer layer, a step of dissolving the resin having an acidic group in an ammonia aqueous solution and preparing a coating fluid for forming the first transparent transfer layer including a resin in which at least some of acidic groups is ammonium-chlorinated is preferably included.

—Resin Having Acidic Group—

The resin having an acidic group is a resin that is soluble in an aqueous solvent (preferably water or a mixed solvent of a lower alcohol having 1 to 3 carbon atoms and water), and can be appropriately selected from well-known resins without any particular limitation. As a preferred example of the resin having an acidic group, resins having a monovalent acidic group (carboxyl group or the like) are exemplified. The resin included in the first transparent transfer layer is particularly preferably a resin having a carboxyl group.

The resin having an acidic group is preferably an alkali-soluble resin.

The alkali-soluble resin is a linear organic high molecular weight polymer and can be appropriately selected from polymers having at least one group that accelerates alkali solubility in the molecule. As the group that accelerates alkali solubility, that is, the acidic group, for example, a carboxyl group, a phosphoric acid group, a sulfonic acid group, and the like are exemplified, and a carboxyl group is preferred.

As the alkali-soluble resin, copolymers including a structural unit selected from (meth)acrylic acid and styrene in a main chain are preferably exemplified. As the alkali-soluble resin, resins that are soluble in an organic solvent and can be developed by a weak alkali aqueous solution are more preferably exemplified.

In addition, the resin having an acidic group is preferably a (meth)acrylic resin having an acidic group, more preferably a copolymer resin of (meth)acrylic acid and a vinyl compound, and particularly preferably a copolymer resin of (meth)acrylic acid and allyl (meth)acrylate.

Particularly, the first transparent transfer layer preferably includes, as the resin, a copolymer having a structural unit derived from (meth)acrylic acid and a structural unit derived from styrene and more preferably includes a copolymer having a structural unit derived from (meth)acrylic acid, a structural unit derived from styrene, and a structural unit derived from (meth)acrylic acid ester having an ethyleneoxy chain.

The resin that is used for the first transparent transfer layer includes a copolymer having a structural unit derived from (meth)acrylic acid and a structural unit derived from styrene and further includes a copolymer having a structural unit derived from (meth)acrylic acid, a structural unit derived from styrene, and a structural unit derived from (meth)acrylic acid ester having an ethyleneoxy chain, and thus film thickness uniformity at the time forming the first transparent transfer layer becomes favorable.

As the resin having an acidic group, a commercially available product may be used. The commercially available product of the resin having an acidic group is not particularly limited and can be appropriately selected according to the purpose. As the commercially available product of the resin having an acidic group, for example, ARUFON (registered trademark) UC3000, UC3510, UC3080, UC3920, UF5041 (all trade name) manufactured by Toagosei Co., Ltd., JONCRYL (registered trademark) 67, JONCRYL 611, JONCRYL 678, JONCRYL 690, JONCRYL 819 (all trade name) manufactured by BASF, and the like are exemplified.

The content of the resin having an acidic group is preferably 10% by mass to 80% by mass, more preferably 15% by mass to 65% by mass, and particularly preferably 20% by mass to 50% by mass with respect to the total mass of the first transparent transfer layer.

—Other Resins—

The first transparent transfer layer may further include other resins having no acidic group. Other resins having no acidic group are not particularly limited.

—Metal Oxide Particles—

The first transparent transfer layer preferably includes metal oxide particles. In a case where the first transparent transfer layer includes metal oxide particles, it is possible to adjust the refractive index and the light transmittance.

The first transparent transfer layer is capable of including metal oxide particles in a random proportion depending on the kinds and contents of the resin and the polymerizable monomer being used, the kind of the metal oxide particles being used, and the like.

The kind of the metal oxide particles is not particularly limited, and well-known metal oxide particles can be used. From the viewpoint of transparency and the viewpoint of controlling the refractive index to be in a range of the refractive index of the first transparent transfer layer, the first transparent transfer layer preferably contains at least one of zirconium oxide particles (ZrO₂ particles), Nb₂O₅ particles, titanium oxide particles (TiO₂ particles), or silicon dioxide particles (SiO₂ particles). Among these, from the viewpoint of easiness in adjusting the refractive index of the transfer layer to 1.6 or higher, the metal oxide particles in the first transparent transfer layer are more preferably zirconium oxide particles or titanium oxide particle and still more preferably zirconium oxide particles.

As the silicon dioxide particles, for example, colloidal silica, fumed silica, and the like are exemplified, and as examples of commercially available products on the market, SNOWTEX ST-N (colloidal silica; non-volatile content: 20%) and SNOWTEX ST-C (colloidal silica; non-volatile content: 20%) manufactured by Nissan Chemical Industries, Ltd.), and the like are exemplified.

As examples of the zirconium oxide particles, NANOUSE OZ-S30M (methanol dispersion liquid, non-volatile content: 30.5% by mass) manufactured by Nissan Chemical Corporation, SZR-CW (water dispersion liquid, non-volatile content: 30% by mass) and SZR-M (methanol dispersion liquid, non-volatile content: 30% by mass) manufactured by Sakai Chemical Industry Co., Ltd., and the like are exemplified.

As examples of the titanium oxide particles, TS-020 (water dispersion liquid, non-volatile content: 25.6% by mass) manufactured by Teika Pharmaceutical Co., Ltd., TITANIA SOL R (methanol dispersion liquid, non-volatile content: 32.1% by mass) manufactured by Nissan Chemical Corporation, and the like are exemplified.

In a case of using zirconium oxide particles as metal oxide particles, a content of zirconium oxide particles is preferably 1% by mass to 95% by mass, more preferably 20% by mass to 90% by mass, and still more preferably 40% by mass to 85% by mass with respect to a mass of the total solid content of the first transparent transfer layer, from the viewpoint that a cover-target-covering property such as an electrode-pattern-covering property becomes favorable, and visibility of cover target can be effectively ameliorated.

In a case of using titanium oxide particles as metal oxide particles, a content of titanium oxide particles is preferably 1% by mass to 95% by mass, more preferably 20% by mass to 90% by mass, and still more preferably 40% by mass to 85% by mass with respect to a mass of the total solid content of the first transparent transfer layer, from the viewpoint that a cover-target-covering property such as an electrode-pattern-covering property becomes favorable, and visibility of cover target can be effectively ameliorated.

The refractive index of the metal oxide particle is preferably higher than the refractive index of a transparent film formed of a composition obtained by removing the metal oxide particles from the coating fluid for forming the first transparent transfer layer.

Specifically, the first transparent transfer layer of the transfer material preferably contains metal oxide particles having a refractive index of 1.5 or higher, more preferably contains particles having a refractive index of 1.55 or higher, still more preferably contains particles having a refractive index of 1.7 or higher, particularly preferably contains particles having a refractive index of 1.9 or higher, and most preferably contains particles having a refractive index of 2.0 or higher.

Here, the refractive index being 1.5 or higher means that the average refractive index for light having a wavelength of 550 nm is 1.5 or higher. The average refractive index is a value obtained by dividing the sum of the measurement values of the refractive index for light having a wavelength of 550 nm by the number of measurement points.

The average primary particle diameter of the metal oxide particles is preferably 100 nm or less, more preferably 50 nm or less, and still more preferably 20 nm or less from the viewpoint of optical performance such as haze.

The average primary particle diameter of the metal oxide particles is a value obtained by measuring the diameters of 100 random particles by observation using a transmission electron microscope (TEM) and arithmetically averaging the 100 diameters.

The first transparent transfer layer may singly include one kind of the metal oxide particles or may include two or more kinds of the metal oxide particles.

The content of the metal oxide particles in the first transparent transfer layer is preferably 1% by mass to 95% by mass, more preferably 20% by mass to 90% by mass, and still more preferably 40% by mass to 85% by mass of the total solid content mass of the first transparent transfer layer regardless of the kind of the metal oxide particles. In a case where the content of the metal oxide particles is in the above-described range, a covering property for transparent electrode patterns after transfer is further improved.

The first transparent transfer layer is capable of including other components in addition to the resin and the metal oxide particles.

—Metal Oxidation Suppressor—

The first transparent transfer layer preferably includes a metal oxidation suppressor.

The metal oxidation suppressor is preferably a compound having an aromatic ring including a nitrogen atom in the molecule.

In addition, in the metal oxidation suppressor, the aromatic ring including a nitrogen atom is preferably at least one ring selected from the group consisting of an imidazole ring, a triazole ring, a tetrazole ring, a thiadiazole ring, or a fused ring of the above-described ring and another aromatic ring, and the aromatic ring including a nitrogen atom is more preferably an imidazole ring or a fused ring of an imidazole ring and another aromatic ring.

The another aromatic ring may be a homocyclic ring or a heterocyclic ring, but is preferably a homocyclic ring, more preferably a benzene ring or a naphthalene ring, and still more preferably a benzene ring.

As a preferred metal oxidation suppressor, imidazole, benzimidazole, tetrazole, mercapto thiadiazole, and benzotriazole are preferably exemplified, and imidazole, benzimidazole, and benzotriazole are more preferred. As the metal oxidation suppressor, a commercially available product may be used, and preferably, it is possible to use, for example, BT120 including benzotriazole manufactured by Johoku Chemical Co., Ltd. and the like.

In addition, the content of the metal oxidation suppressor is preferably 0.1% by mass to 20% by mass, more preferably 0.5% by mass to 10% by mass, and still more preferably 1% by mass to 5% by mass of the total mass of the first transparent transfer layer.

—Polymerizable Monomer—

The first transparent transfer layer preferably includes a polymerizable monomer such as a polymerizable monomer or a thermopolymerizable monomer from the viewpoint of increasing the strength or the like of a film by curing the first transparent transfer layer. As the polymerizable monomer, an ethylenically unsaturated compound is preferable, and a (meth)acrylate compound and a (meth)acrylamide compound are more preferable. The first transparent transfer layer may include only the above-described monomer having an acidic group as the polymerizable monomer.

As the polymerizable monomer that is used in the first transparent transfer layer, it is possible to use the polymerizable compounds described in Paragraphs 0023 and 0024 of JP4098550B. Among them, pentaerythritol tetraacrylate, pentaerythritol triacrylate, and tetraacrylate of a pentaerythritol ethylene oxide adduct can be preferably used. These polymerizable monomers may be used singly or a plurality of the polymerizable monomers may be used in combination. In the case of using a mixture of pentaerythritol tetraacrylate and pentaerythritol triacrylate, the ratio of pentaerythritol triacrylate is preferably 0% to 80% and more preferably 10% to 60% in terms of the mass ratio.

As the polymerizable monomer that is used in the first transparent transfer layer, water-soluble polymerizable monomers represented by Structural Formula 1 below, a pentaerythritol tetraacrylate mixture (NK ESTER A-TMMT: manufactured by Shin-Nakamura Chemical Co., Ltd., containing approximately 10% of triacrylate as an impurity), a mixture of pentaerythritol tetraacrylate and triacrylate (NK ESTER A-TMM3LM-N manufactured by Shin-Nakamura Chemical Co., Ltd., 37% of triacrylate), a mixture of pentaerythritol tetraacrylate and triacrylate (NK ESTER A-TMM-3L manufactured by Shin-Nakamura Chemical Co., Ltd., 55% of triacrylate), a mixture of pentaerythritol tetraacrylate and triacrylate (NK ESTER A-TMM3 manufactured by Shin-Nakamura Chemical Co., Ltd., 57% of triacrylate), tetraacrylate of a pentaerythritol ethylene oxide adduct (KAYARAD RP-1040 manufactured by Nippon Kayaku Co., Ltd.), and the like can be exemplified.

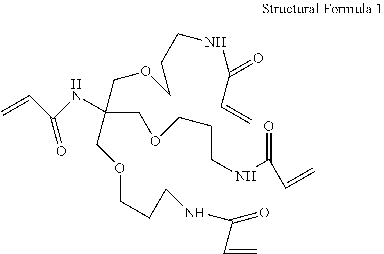 [SMILES: C=CC(=O)NCCCOCC(COCCCNC(=O)C=C)(COCCCNC(=O)C=C)NC(=O)C=C]

As other polymerizable monomers that are used in the first transparent transfer layer, polymerizable monomers that are soluble in an aqueous solvent such as water or a solvent mixture of a lower alcohol having 1 to 3 carbon atoms and water and monomers having an acidic group are preferred. As the polymerizable monomers that are soluble in an aqueous solvent, monomers having a hydroxyl group and monomers having an ethylene oxide or a polypropylene oxide and a phosphoric acid group in the molecule are exemplified. As the monomers having an acidic group, polymerizable monomers containing a carboxyl group are preferred, acrylic monomers such as (meth)acrylate or derivatives thereof can be more preferably used, and, among them, ARONIX TO-2349 (Toagosei Co., Ltd.) is particularly preferred.

—Polymerization Initiator—

The first transparent transfer layer is capable of including a polymerization initiator.

The polymerization initiator that is used in the first transparent transfer layer is preferably a polymerization initiator that is soluble in an aqueous solvent. As the polymerization initiator that is soluble in an aqueous solvent, IRGACURE 2959, photopolymerization initiators of Structural Formula 2 below, and the like are exemplified.

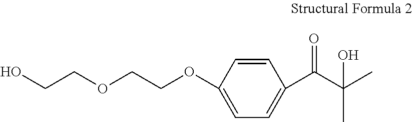 [SMILES: CC(C)(O)C(=O)c1ccc(OCCOCCO)cc1]

Hitherto, a case where the transfer material is a negative-type material has been mainly described, but the transfer material may be a positive-type material. In a case where the transfer material is a positive-type material, a material described in, for example, JP2005-221726A can be used for the first transparent transfer layer, but the material is not limited thereto.

The first transparent transfer layer can be formed by applying and drying a solution obtained by dissolving a resin composition for forming the first transparent transfer layer including at least the polymerizable monomer and the resin in a solvent (referred to as the coating fluid for forming the first transparent transfer layer).

The coating fluid for forming the first transparent transfer layer may contains a solvent. Examples of solvents include water, methanol, diacetone alcohol, ethylene glycol, propylene glycol, isobutyl alcohol, and the like.

(Third Transparent Transfer Layer)

The third transparent transfer layer is disposed on the surface (one of the surfaces) of the second transparent transfer layer which is on the side opposite to the side having the first transparent transfer layer, between the temporary support and the second transparent transfer layer, and is a transparent layer having a refractive index higher than a refractive index of the second transparent transfer layer. In a case where a touch sensor is produced as described later, the third transparent transfer layer can form the third transparent layer after transfer.

As shown in FIG. 1, the transfer material of the present disclosure may adopt, for example, an aspect in which the third transparent transfer layer 25 is disposed on one surface of the second transparent transfer layer 23 between the temporary support 10 and the second transparent transfer layer 23.

The refractive index and thickness of the third transparent transfer layer are the same as those of the third transparent layer to be described later.

Specifically, a refractive index of the third transparent transfer layer is preferably 1.6 or more, more preferably 1.6 to 1.9, and still more preferably 1.65 to 1.8.

A thickness of the third transparent transfer layer is preferably 0.5 μm or less, more preferably 0.3 μm (300 nm) or less, still more preferably 20 nm to 300 nm, further still more preferably 30 nm to 200 nm, and particularly preferably 30 nm to 100 nm.

The third transparent transfer layer can be formed in the same manner as the first transparent transfer layer intended to transfer and form the above-described first transparent layer.

As components that are used in the third transparent transfer layer, it is possible to use the same components as the components that can be used for the first transparent transfer layer. The third transparent transfer layer preferably includes metal oxide particles. In a case where the first transparent transfer layer includes metal oxide particles, it is possible to adjust the refractive index and the light transmittance.

Regarding metal oxide particles, the same particles as the metal oxide particles incorporated in the first transparent transfer layer are applied, and preferred aspects thereof are also the same. The kind of the metal oxide particles is not particularly limited, and well-known metal oxide particles can be used. From the viewpoint of transparency and the viewpoint of controlling the refractive index to be in a range of the refractive index of the first transparent transfer layer, the first transparent transfer layer preferably contains at least one of zirconium oxide particles (ZrO₂ particles), Nb₂O₅ particles, titanium oxide particles (TiO₂ particles), or silicon dioxide particles (SiO₂ particles). Among these, from the viewpoint of easiness in adjusting the refractive index of the transfer layer to 1.6 or higher, the metal oxide particles in the first transparent transfer layer are more preferably zirconium oxide particles or titanium oxide particle and still more preferably zirconium oxide particles.

As the silicon dioxide particles, for example, colloidal silica, fumed silica, and the like are exemplified, and as examples of commercially available products on the market, SNOWTEX ST-N (colloidal silica; non-volatile content: 20%) and SNOWTEX ST-C (colloidal silica; non-volatile content: 20%) manufactured by Nissan Chemical Industries, Ltd.), and the like are exemplified.

The third transparent transfer layer can be formed by applying and drying a solution obtained by dissolving a resin composition for forming the third transparent transfer layer including at least the polymerizable monomer and the resin in a solvent (referred to as the coating fluid for forming the third transparent transfer layer).

The coating fluid for forming the third transparent transfer layer may contains a solvent. Examples of solvents include water, methanol, 1-methoxy-2-propyl acetate, methyl ethyl ketone, diacetone alcohol, ethylene glycol, propylene glycol, isobutyl alcohol, and the like.

(Fourth Transparent Transfer Layer)

In addition to the first transparent transfer layer, the second transparent transfer layer, and the third transparent transfer layer, the transfer material of the present disclosure preferably further includes the fourth transparent transfer layer that is disposed on the side of the first transparent transfer layer opposite to the side in contact with the second transparent transfer layer, and has a refractive index lower than a refractive index of the first transparent transfer layer, from the viewpoint of further improving an electrode-pattern-covering property.

As shown in FIG. 2, the transfer material of the present disclosure may adopt, for example, an aspect in which a fourth transparent transfer layer 27 having a refractive index lower than a refractive index of the first transparent transfer layer 21 is further disposed on the side of the first transparent transfer layer 21 opposite to the side in contact with the second transparent transfer layer 23.

In a case where a touch sensor is produced as described later, the fourth transparent transfer layer can form the fourth transparent layer after transfer.

The refractive index and thickness of the fourth transparent transfer layer are the same as those of the fourth transparent layer to be described later.

Specifically, the refractive index of the fourth transparent transfer layer is preferably lower than the refractive index of the first transparent layer, and the refractive index is preferably less than 1.6. Among values, the refractive index thereof is preferably 1.2 or more and less than 1.6, more preferably 1.3 to 1.5, and still more preferably 1.4 to 1.5 from the viewpoint of more effectively ameliorating visibility of a structure.

In addition, a thickness of the fourth transparent transfer layer is preferably 300 nm or less, more preferably 200 nm or less, still more preferably 10 nm to 100 nm, and particularly preferably 10 nm to 50 nm.

Among the above-mentioned values, a case in which the fourth transparent transfer layer has a refractive index of 1.3 to 1.5 and a thickness of 10 nm to 50 nm is suitable.

The fourth transparent transfer layer can be formed in the same manner as the first transparent transfer layer intended to transfer and form the above-described first transparent layer.

As components that are used in the fourth transparent transfer layer, it is possible to use the same components as the components that can be used for the first transparent transfer layer. The particles incorporated in the fourth transparent transfer layer are preferably particles imparting a low refractive index, preferably inorganic oxide particles having a refractive index of less than 1.6, and more preferably SiO₂ particles, or the like.

(Fifth Transparent Transfer Layer)

In addition to the first transparent transfer layer, the second transparent transfer layer, and the third transparent transfer layer, the transfer material of the present disclosure preferably further includes the fifth transparent transfer layer that is disposed on the side of the third transparent transfer layer opposite to the side in contact with the second transparent transfer layer, that is, between the temporary support and the third transparent transfer layer, and that has a refractive index lower than a refractive index of the third transparent transfer layer, from the viewpoint of further improving an electrode-pattern-covering property.

As shown in FIG. 2, the transfer material of the present disclosure may adopt, for example, an aspect in which a fifth transparent transfer layer 29 having a refractive index lower than a refractive index of the third transparent transfer layer 25 is further disposed between the temporary support 10 and the third transparent transfer layer 25.

In a case where a touch sensor is produced as described later, the fifth transparent transfer layer can form the fifth transparent layer after transfer.

The refractive index and thickness of the fifth transparent transfer layer are the same as those of the fifth transparent layer to be described later.

Specifically, the refractive index of the fifth transparent transfer layer is preferably lower than the refractive index of the third transparent layer, and the refractive index is more preferably less than 1.6. In a case where the fifth transparent transfer layer has a lower refractive index than the first transparent transfer layer, particularly, a second-electrode-pattern-covering property can be improved, and visibility of electrode patterns can be further ameliorated. The refractive index of the fifth transparent transfer layer is preferably 1.2 or more and less than 1.6, more preferably 1.3 to 1.5, and still more preferably 1.4 to 1.5.

In addition, a thickness of the fifth transparent transfer layer is preferably 300 nm or less, more preferably 200 nm or less, still more preferably 10 nm to 100 nm, and particularly preferably 10 nm to 50 nm.

Among the above-mentioned values, a case in which the fifth transparent transfer layer has a refractive index of 1.3 to 1.5 and a thickness of 10 nm to 50 nm is suitable.

The fifth transparent transfer layer can be formed in the same manner as the first transparent transfer layer intended to transfer and form the above-described first transparent layer. The particles incorporated in the fifth transparent transfer layer are preferably particles imparting a low refractive index, more preferably inorganic oxide particles having a refractive index of less than 1.6, and still more preferably SiO₂ particles, or the like.

The transfer material of the present disclosure preferably adopt an aspect in which the fourth transparent transfer layer having a refractive index lower than a refractive index of the first transparent transfer layer is disposed on the side of the first transparent transfer layer opposite to the side in contact with the second transparent transfer layer, and the fifth transparent transfer layer having a refractive index lower than a refractive index of the third transparent transfer layer is disposed on the side of the third transparent transfer layer opposite to the side in contact with the second transparent transfer layer, in addition to the first transparent transfer layer, the second transparent transfer layer, and the third transparent transfer layer, from the viewpoint of further improving an electrode-pattern-covering property.

Furthermore, from the viewpoint of further improving the electrode-pattern-covering property, a case is preferable, in which the first transparent transfer layer has a refractive index of 1.65 to 1.8 and a thickness of 30 nm to 200 nm, the second transparent transfer layer has a refractive index of 1.4 to 1.55 and a thickness of 1 μm to 10 μm, the third transparent transfer layer has a refractive index of 1.65 to 1.8 and a thickness of 30 nm to 200 nm, the fourth transparent transfer layer has a refractive index of 1.3 to 1.5 and a thickness of 10 nm to 100 nm, and the fifth transparent transfer layer has a refractive index of 1.3 to 1.5 and a thickness of 10 nm to 100 nm.

The transfer material may have, in addition to a variety of transparent transfer layers described above, other random layers such as a thermoplastic resin layer, an interlayer, and a protective film as long as the effect is not impaired.

<Touch Sensor>

The touch sensor of the present disclosure is a touch sensor which has a structure in which an electrode extending in one direction and an electrode extending in the other direction are disposed on one side of a base material via a transparent layer, and which includes at least the first transparent layer, the second transparent layer, and the third transparent layer as transparent layers. As the electrode, a transparent electrode formed of a metal oxide such as Indium Tin Oxide (ITO) is preferable.

Specifically, the touch sensor includes, in an overlapping manner, a substrate that has a base material and a patterned first electrode (hereinafter referred to as a first electrode pattern); a patterned second electrode (hereinafter referred to as a second electrode pattern); a second transparent layer that is disposed between the first electrode and the second electrode and has a thickness of 0.5 μm or more and less than 25 μm; a first transparent layer that is disposed between the first electrode and the second transparent layer (preferably on a surface of the second transparent layer between the first electrode and the second transparent layer), and has a refractive index higher than a refractive index of the second transparent layer; and a third transparent layer that is disposed between the second electrode and the second transparent layer (preferably on a surface of the second transparent layer between the second electrode and the second transparent layer), and has a refractive index higher than a refractive index of the second transparent layer. That is, the touch sensor of the present disclosure has a laminate structure of the second electrode/the third transparent layer/the second transparent layer/the first transparent layer/the substrate (=the first electrode/the base material).

In the related art, a touch sensor which has a structure in which an electrode extending in one direction and an electrode extending in the other direction are disposed on one side of a base material via a transparent layer is known. However, there has been a problem of electrode patterns being visually recognized during use on a touch panel screen including the touch sensor.

Among the above-mentioned techniques in the related art, for example, JP2014-108541A proposes the structure in which the second curable transparent resin layer having a refractive index higher than a refractive index of the first curable transparent resin layer is disposed on one side of the first curable transparent resin layer, as a technique for avoiding visibility of electrode patterns. However, in this technique, it is necessary to install a bridge wire or to install an insulating layer between sensor electrodes.

In addition, WO20061126604A discloses the structure in which the overcoat layer is laminated on a thick adhesive layer having a thickness of 25 μm or more. However, the technique described in WO2006/126604A has a problem of the laminate being thick.

In view of the above circumstances, the touch sensor of the present disclosure has a laminate structure in which the second transparent layer having a thickness of 0.5 μm or more and less than 25 μm, and the first transparent layer and the third transparent layer which have a refractive index higher than a refractive index of the second transparent layer and which are disposed so as to sandwich the second transparent layer therebetween, are disposed to overlap between the patterned first electrode and second electrode, and thereby an electrode-pattern-covering property is further improved, and visibility of electrode patterns is effectively ameliorated.

An example of one embodiment (a first embodiment) of the touch sensor of the present disclosure will be described with reference to FIG. 3. However, the touch sensor according to the present disclosure is not limited to the embodiment shown in FIG. 3. In addition, the components included in the first embodiment shown in FIG. 3 can be applied to other embodiments in which other components are further added to the first embodiment.

FIG. 3 is a cross-sectional view of a laminate which shows the first embodiment of the touch sensor in a state in which the electrode pattern is not visible.

As shown in FIG. 3, a touch sensor 300 according to the embodiment of the present disclosure includes a first electrode (a first electrode pattern) 51 and a second electrode (a second electrode pattern) 53, which are formed in a pattern, on a base material 60, and a first transparent layer 31, a second transparent layer 33, and a third transparent layer 35 are laminated in this order from the first electrode pattern 51 side so that the first electrode pattern 51 and the second electrode pattern 53 are separately disposed.

The first electrode pattern 51 may be disposed as a structure having a plurality of first island-shaped electrode portions disposed at intervals in a first direction on the substrate, and first wire portions that electrically connect the first island-shaped electrode portions adjacent to each other. A pattern shape of the first electrode pattern may be selected in accordance with the touch sensor to be produced, and may have any structure.

Refractive indexes of the first island-shaped electrode portion and the first wire portion are preferably in a range of 1.75 to 2.1.

A material of the first island-shaped electrode portion is not particularly limited, but needs to be a material capable of forming a transparent conductive film, and a well-known material can be used. As specific materials, for example, metal oxides such as indium tin oxide (ITO), aluminum-doped zinc oxide (AZO), and indium zinc oxide (IZO) are exemplified.

As the first island-shaped electrode portion, it is possible to use, for example, a translucent metal oxide film such as an ITO film, an IZO film, or a SiO₂ film; a metal film of Al, Zn, Cu, Fe, Ni, Cr, Mo, Ag, Au, or the like; an alloy film of a plurality of metals such as a copper-nickel alloy; or the like.

A thickness of the first island-shaped electrode portion can be set to 10 nm to 200 nm.

In addition, an amorphous ITO film may be transformed to a polycrystalline ITO film by firing. In the case of forming a conductive pattern using an ITO film or the like, it is possible to refer to the description of Paragraphs 0014 to 0016 of JP4506785B.

The shape of the first island-shaped electrode portion is not particularly limited and may be any of a square shape, a rectangular shape, a rhombic shape, a trapezoidal shape, a pentagonal or higher polygonal shape, or the like, but a square shape, a rhombic shape, or a hexagonal shape is suitable since a fine packed structure is easily formed.

The first wire portion is not particularly limited as long as the first wire portion is a member capable of electrically connecting the first island-shaped electrode portions adjacent to each other. To the first wire portion, it is possible to apply the same material as the first island-shaped electrode portions, and the thickness is also the same. In addition, an amorphous ITO film may be transformed to a polycrystalline ITO film by firing.

The second electrode pattern is disposed on the side of the third transparent layer opposite to the side on which the first electrode pattern is disposed. The second electrode pattern may be disposed as a structure having a plurality of second island-shaped electrode portions disposed at intervals in a second direction intersecting the first direction in the first electrode pattern, and second wire portions that electrically connect the second island-shaped electrode portions adjacent to each other. A pattern shape of the second electrode pattern may be selected in accordance with the touch sensor to be produced, and may have any structure.

Refractive indexes of the second island-shaped electrode portion and the second wire portion are preferably in a range of 1.75 to 2.1.

A material of the second island-shaped electrode portion is not particularly limited, but needs to be a material capable of forming a transparent conductive film, and a well-known material can be used. Specific materials are the same as the material of the first island-shaped electrode portion.

As the second island-shaped electrode portion, it is possible to use, for example, a translucent metal oxide film such as an ITO film, an IZO film, or a SiO₂ film; a metal film of Al, Zn, Cu, Fe, Ni, Cr, Mo, Ag, Au, or the like; an alloy film of a plurality of metals such as a copper-nickel alloy; or the like.

A thickness of the second island-shaped electrode portion can be set to 10 nm to 200 nm.

In addition, an amorphous ITO film may be transformed to a polycrystalline ITO film by firing. In the case of forming a conductive pattern using an ITO film or the like, it is possible to refer to the description of Paragraphs 0014 to 0016 of JP4506785B.

In addition, a shape of the second island-shaped electrode portion is not particularly limited and may be any of a square shape, a rectangular shape, a rhombic shape, a trapezoidal shape, a pentagonal or higher polygonal shape, or the like, but a square shape, a rhombic shape, or a hexagonal shape is suitable since a fine packed structure is easily formed.

The second wire portion is not particularly limited as long as the second wire portion is a member capable of electrically connecting the second island-shaped electrode portions adjacent to each other. To the second wire portion, it is possible to apply the same material as the second island-shaped electrode portions, and the thickness is also the same. In addition, an amorphous ITO film may be transformed to a polycrystalline ITO film by firing.

Particularly, the second wire portion is preferably a transparent electrode. In a case where the second wire portion is disposed as a transparent electrode, the visibility of the bridge wire is more significantly decreased in a produced touch sensor, and an appearance-improving effect is strong.

The refractive indexes of the first electrode pattern 51 and the second electrode pattern 53 in the touch sensor of the embodiment of the present disclosure are preferably in a range of 1.75 to 2.1.

The base material 60 is preferably a transparent base material, and more preferably an electrically insulating base material.

A refractive index of the base material is preferably 1.5 to 1.6 and more preferably 1.5 to 1.55. In the case where the refractive index of the base material is within the above range, the effect of covering electrode patterns can be obtained.

As the electrically insulating base material, for example, a glass base material, and resin films such as a polyethylene terephthalate (PET) film, a polycarbonate (PC) film, a cycloolefin polymer (COP) film, and a polyvinyl chloride (PVC) film are exemplified.

A COP film is preferred since the COP film is excellent not only in optical isotropy but also in dimensional stability and, furthermore, processing accuracy. In a case where the transparent base material is a glass substrate, the thickness may be 0.3 mm to 3 mm. In addition, in a case where the base material is a resin film, the thickness may be 20 μm to 3 mm.

Next, the first transparent layer, the second transparent layer, and the third transparent layer which are disposed between the first electrode pattern 51 and the second electrode pattern 53 will be described.

First, the second transparent layer 33 will be described.

The second transparent layer 33 in the present disclosure is a transparent layer having a thickness of 0.5 μm or more and less than 25 μm. An image of the electrode pattern is covered by an interference action of light reflected from the interface between the first transparent layer 31 and the third transparent layer 35 which have a higher refractive index than the second transparent layer, which indicates that the second transparent layer 33 dramatically ameliorate visibility of electrode patterns.

The second transparent layer of the present disclosure is a transparent layer having a refractive index lower than a refractive index of the first transparent layer and the third transparent layer, and a refractive index of the second transparent layer is preferably 1.4 to 1.6, more preferably 1.4 to 1.55, and still more preferably 1.45 to 1.55.

A thickness of the second transparent layer is 0.5 μm or more and less than 25 μm. In the case where the thickness of the second transparent layer is 0.5 μm or more, a desired refractive index is easily obtained. In addition, in the case where the thickness of the second transparent layer is less than 25 μm, it indicates that the second transparent layer is not too thick, and it is possible to increase a desired degree of freedom in design of a touch sensor according to the purpose or use applications.

A thickness of the second transparent layer is preferably 0.5 μm to 20 μm and is more preferably 1 μm to 10 μm, from the viewpoint of more effectively exhibiting transparency, and an interference action of light which is obtained together from the first transparent layer and the third transparent layer which are adjacent to the second transparent layer.

It is particularly preferable that the second transparent layer have a refractive index of 1.4 to 1.55 and a thickness of 1 μm to 10 μm.

The thickness of the second transparent layer is an average thickness measured using a scanning electron microscope (SEM). Specifically, a segment of the touch panel is formed using an ultramicrotome, a 5 mm-long region in a cross section of the segment is scanned using SEM, and the thicknesses of the second transparent layer are measured. Next, the arithmetic average of the measurement values of the thicknesses at 20 places separated at equal intervals was obtained and regarded as the average thickness.

A material of the second transparent layer is not particularly limited as long as it can be a transparent layer having a thickness of 0.5 μm or more and less than 25 μm (preferably having a refractive index of 1.4 to 1.6). For the second transparent layer, for example, a metal oxide layer formed by sputtering may be used or a cured layer obtained by a curing reaction of a curable component in the above-described second transparent transfer layer may be used.

The second transparent layer is preferably provided as a transfer layer formed by transferring, for example, the above-described second transparent transfer layer of the transfer material onto the first transparent layer to be described later by a transfer method using a transfer material. In a case where the first transparent layer and the second transparent layer are transfer layers, the respective layers are likely to be formed in highly uniform thicknesses, and thus a stable refractive index can be obtained, and an electrode-pattern-covering property using the interference of light is more favorable.

In addition, the second transparent layer may be a layer formed by a curing reaction, and is preferably a cured substance of a composition including an alkali-soluble resin, a polymerizable monomer, and a photopolymerization initiator. The weight-average molecular weight of the alkali-soluble resin is preferably 35,000 or less, more preferably 25,000 or less, and still more preferably 20,000 or less.

The detail of a component forming the second transparent layer is as described in the above-described section of the second transparent transfer layer in the transfer material which includes the alkali-soluble resin, the polymerizable monomer, and the photopolymerization initiator.

The content of a component derived from the alkali-soluble resin in the second transparent layer is preferably 30% by mass or more of the solid content of the second transparent layer. The content of the component derived from the alkali-soluble resin is preferably 30% by mass or more from the viewpoint of forming the second transparent layer in a tapered shape. The content of the component derived from the alkali-soluble resin is more preferably 40% by mass to 70% by mass of the solid content of the second transparent layer.

Next, the first transparent layer 31 will be described.

The first transparent layer in the present disclosure is a highly transparent layer that is disposed between the first electrode and the second transparent layer, and has a refractive index higher than a refractive index of the second transparent layer. The first transparent layer 31 is disposed at an appropriate thickness between the second transparent layer having a lower refractive index than the first transparent layer, and the first electrode (the first electrode pattern) 51, and thereby exhibits an effect of covering electrode patterns by an interference action of light reflected from the interface between the layers or light reflected from the interface between the layer and the electrode. Accordingly, visibility of electrode patterns from the outside is ameliorated.

A refractive index of the first transparent layer in the present disclosure is preferably 1.6 or more, more preferably 1.6 to 1.9, and still more preferably 1.65 to 1.8.

A thickness of the first transparent layer is preferably 0.5 μm or less, more preferably 0.3 μm (300 nm) or less, still more preferably 20 nm to 300 nm, further still more preferably 30 nm to 200 nm, and particularly preferably 30 nm to 100 nm.

Among the above-mentioned values, it is preferable that the first transparent layer have a refractive index of 1.65 to 1.8 and a thickness of 30 nm to 200 nm, and it is more preferable that the first transparent layer have a refractive index of 1.65 to 1.8 and a thickness of 30 nm to 100 nm.

A refractive index of the first transparent layer is preferably higher than a refractive index of the second transparent layer by 0.05 or more, more preferably by 0.1 or more, and further preferably by 0.15 or more.

In this case, the second transparent layer is superimposed on the first transparent layer in the structure, and the refractive indexes of the layers decrease from a side close to the first electrode pattern toward a side far from the electrode patterns. Accordingly, electrode patterns, such as ITO having a relatively high refractive index, becomes unlikely to be visible from the outside, and thereby a touch sensor having excellent appearance can be obtained.

A refractive index of the first transparent layer can be adjusted by incorporating, for example, particles, and the first transparent layer preferably contains metal oxide particles. Regarding details of metal oxide particles, the same particles as the above-described metal oxide particles incorporated in the first transparent transfer layer are applied, and preferred aspects thereof are also the same. The first transparent layer particularly preferably contains at least one of zirconium oxide particles (ZrO₂ particles), Nb₂O₅ particles, titanium oxide particles (TiO₂ particles), or silicon dioxide particles (SiO₂ particles).

A thickness of the first transparent layer is an average thickness measured using a transmission electron microscope (TEM). Specifically, a segment of the touch panel is formed using an ultramicrotome, a 5 mm-long region in a cross section of the segment is scanned using TEM, and the thicknesses of the second transparent layer are measured. Next, the arithmetic average of the measurement values of the thicknesses at 20 places separated at equal intervals was obtained and regarded as the average thickness.

A material of the first transparent layer is not particularly limited as long as the first transparent layer is a transparent layer (preferably, a transparent layer having a refractive index of 1.6 or more and a thickness of less than 500 nm (preferably 300 nm or less) which has a refractive index higher than a refractive index of the second transparent layer. For the first transparent layer, for example, a metal oxide layer formed by a vacuum deposition method or a sputtering method may be used, or a cured layer formed by a curing reaction of a curable component in the above-described first transparent transfer layer may be used.

For example, the first transparent layer may be a transfer layer obtained by transferring the above-described first transparent transfer layer of the transfer material onto the first electrode pattern, or may be a transfer layer obtained by a curing reaction.

Details of a component forming the first transparent layer are as described in the section of the above-described first transparent transfer layer in the transfer material.

Next, the third transparent layer 35 will be described.

The third transparent layer 35 in the present disclosure is a highly transparent layer that is disposed between the second electrode and the second transparent layer, and has a refractive index higher than a refractive index of the second transparent layer. Since the third transparent layer 35 is disposed adjacent to the second transparent layer 33, the third transparent layer 35 exhibits an action of covering electrode patterns by an interference action of light which obtained together from the second transparent layer 33 having a lower refractive index than the third transparent layer 35. Accordingly, visibility of electrode patterns from the outside is ameliorated.

A refractive index of the third transparent layer is preferably 1.6 or more, more preferably 1.6 to 1.9, and still more preferably 1.65 to 1.8.

A thickness of the third transparent layer is preferably 0.5 μm or less, more preferably 0.3 μm (300 nm) or less, still more preferably 20 nm to 300 nm, further still more preferably 30 nm to 200 nm, and particularly preferably 30 nm to 100 nm.

Among the above-mentioned values, it is preferable that the third transparent layer have a refractive index of 1.65 to 1.8 and a thickness of 30 nm to 200 nm, and it is more preferable that the first transparent layer have a refractive index of 1.65 to 1.8 and a thickness of 30 nm to 100 nm.

A refractive index of the third transparent layer is preferably higher than a refractive index of the second transparent layer by 0.05 or more, more preferably by 0.1 or more, and further preferably by 0.15 or more.

In this case, the third transparent layer is superimposed on the second transparent layer in the structure, and the refractive indexes of the layers decrease from a side close to the second electrode pattern toward a side far from the electrode patterns. Accordingly, electrode patterns, such as ITO having a relatively high refractive index, becomes unlikely to be visible from the outside, and thereby a touch sensor having excellent appearance can be obtained.

A refractive index of the third transparent layer can be adjusted by incorporating, for example, particles, and the third transparent layer preferably contains metal oxide particles. Regarding details of metal oxide particles, the same particles as the above-described metal oxide particles incorporated in the first transparent transfer layer are applied, and preferred aspects thereof are also the same. The first transparent layer particularly preferably contains at least one of zirconium oxide particles (ZrO₂ particles), Nb₂O₅ particles, titanium oxide particles (TiO₂ particles), or silicon dioxide particles (SiO₂ particles).

The thickness of the third transparent layer is an average thickness measured using a transmission electron microscope (TEM) and can be measured in the same manner as in the case of the first transparent layer.

A material of the third transparent layer is not particularly limited as long as the first transparent layer is a transparent layer (preferably, a transparent layer having a refractive index of 1.6 or more and a thickness of less than 500 nm (preferably 300 nm or less) which has a refractive index higher than a refractive index of the second transparent layer. For the third transparent layer, for example, a metal oxide layer formed by a vacuum deposition method or a sputtering method may be used, or a cured layer formed by a curing reaction of a curable component in the above-described first transparent transfer layer may be used.

For example, the third transparent layer may be a transfer layer formed by transferring the above-described third transparent transfer layer of the transfer material onto the second transfer layer, or may be a layer obtained by a curing reaction.

Details of a component forming the third transparent layer are as described in the section of the above-described third transparent transfer layer in the transfer material.

### Second Embodiment

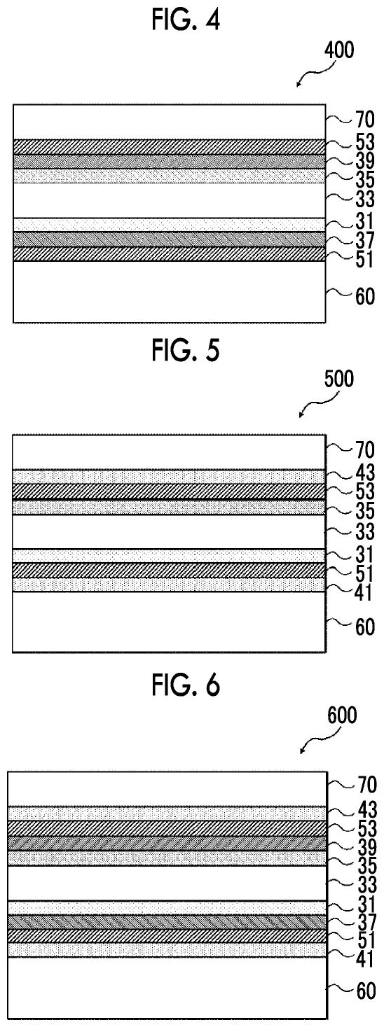

Another embodiment of the touch sensor of the present disclosure may be a second embodiment having the structure shown in FIG. 4. The second embodiment will be described with reference to FIG. 4. In a touch sensor according to the second embodiment, the same components as those of the touch sensor according to the first embodiment are denoted by the same reference numerals, and the description of the components denoted by the same reference numerals is omitted.

That is, the touch sensor of the present disclosure preferably includes a fourth transparent layer having a refractive index lower than a refractive index of the first transparent layer on a side of the first transparent layer opposite to a side in contact with the second transparent layer, and a fifth transparent layer having a refractive index lower than a refractive index of the third transparent layer on a side of the third transparent layer opposite to a side in contact with the second transparent layer.

By disposing the fourth transparent layer and the fifth transparent layer, a laminate structure in which a low-refractive-index layer/a high-refractive-index layer/a low-refractive-index layer are formed from the side of the first electrode pattern or the second electrode pattern is obtained, and thereby the effect of ameliorating visibility of electrode patterns is high.

Specifically, for example, as shown in FIG. 4, a touch sensor 400 of the second embodiment includes a fourth transparent layer 37 having a refractive index lower than a refractive index of the first transparent layer 31 on a side of the first transparent layer 31 opposite to a side in contact with the second transparent layer 33, and a fifth transparent layer 39 having a refractive index lower than a refractive index of the third transparent layer 35 on a side of the third transparent layer 35 opposite to a side in contact with the second transparent layer 33.

Hereinafter, the fourth transparent layer 37 and the fifth transparent layer 39 will be described.

The fourth transparent layer 37 is disposed between the first electrode (the first electrode pattern) 51 and the first transparent layer 31, and is a transparent layer having a lower refractive index than the first transparent layer 31.

A thickness of the fourth transparent layer is preferably 300 nm or less, more preferably 200 nm or less, still more preferably 10 nm to 100 nm, and particularly preferably 10 nm to 50 nm.

The refractive index of the fourth transparent layer is preferably lower than the refractive index of the first transparent layer, and the refractive index is preferably less than 1.6. In a case where the fourth transparent layer has a lower refractive index than the first transparent layer, particularly, a first-electrode-pattern-covering property can be improved, and visibility of electrode patterns can be further ameliorated.

A refractive index of the fourth transparent layer is preferably 1.2 or more and less than 1.6, more preferably 1.3 to 1.5, and still more preferably 1.4 to 1.5.

Among the above-mentioned values, a case in which the fourth transparent layer has a refractive index of 1.3 to 1.5 and a thickness of 10 nm to 100 nm is suitable.

The thickness of the fourth transparent layer is an average thickness measured using a transmission electron microscope (TEM) and can be measured in the same manner as in the case of the first transparent layer.

A material used to form the fourth transparent layer is not particularly limited as long as the fourth transparent layer is a low-refractive index layer having a refractive index lower than that of the first transparent layer (preferably a low-refractive index layer having a refractive index of less than 1.6 and a thickness of 300 nm or less), and it is possible to use the same material as the materials used for the first transparent layer except for a component such as particles having an influence on the refractive index.

For the fourth transparent layer, for example, a metal oxide layer formed by a vacuum deposition method or a sputtering method can be used or a cured layer formed by a curing reaction of a curable component in the above-described first transparent transfer layer may be used.

The fourth transparent layer is preferably, for example, a transfer layer disposed between the first electrode pattern 51 and the first transparent layer 31 by transferring the above-described first transparent transfer layer of the transfer material onto at least the first electrode pattern, and may be a layer formed by a curing reaction.

The details of components used to form the fourth transparent layer are the same as the components of the above-described first transparent transfer layer (except for the particles) in the transfer material, and preferred aspects thereof are also the same. The particles incorporated in the fourth transparent layer are preferably particles imparting a low refractive index, more preferably inorganic oxide particles having a refractive index of less than 1.6, and still more preferably SiO₂ particles, or the like.

The fifth transparent layer 39 is disposed between the second electrode (the second electrode pattern) 53 and the third transparent layer 35, and is a transparent layer having a lower refractive index than the third transparent layer 35.

The refractive index of the fifth transparent layer is preferably lower than the refractive index of the third transparent layer, and the refractive index is preferably less than 1.6. In a case where the fifth transparent layer has a lower refractive index than the third transparent layer, particularly, a second-electrode-pattern-covering property can be improved, and visibility of electrode patterns can be further ameliorated. A refractive index of the fifth transparent layer is preferably 1.2 or more and less than 1.6, more preferably 1.3 to 1.5, and still more preferably 1.4 to 1.5.

A thickness of the fifth transparent layer is preferably 300 nm or less, more preferably 200 nm or less, still more preferably 10 nm to 100 nm, and particularly preferably 10 nm to 50 nm.

Among the above-mentioned values, a case in which the fifth transparent layer has a refractive index of 1.3 to 1.5 and a thickness of 10 nm to 100 nm is suitable.

The thickness of the fifth transparent layer is an average thickness measured using a transmission electron microscope (TEM) and can be measured in the same manner as in the case of the first transparent layer.

A material used to form the fifth transparent layer is not particularly limited as long as the fifth transparent layer is a low-refractive index layer having a refractive index lower than that of the third transparent layer (preferably a low-refractive index layer having a refractive index of less than 1.6 and a thickness of 300 nm or less), and it is possible to use the same material as the materials used for the first transparent layer except for a component such as particles having an influence on the refractive index.

For the fifth transparent layer, for example, a metal oxide layer formed by a vacuum deposition method or a sputtering method can be used or a cured layer formed by a curing reaction of a curable component in the above-described first transparent transfer layer may be used.

The fifth transparent layer is preferably, for example, a transfer layer disposed between the second electrode pattern 53 and the third transparent layer 35 by transferring the above-described first transparent transfer layer of the transfer material onto the third transparent layer, and may be a layer formed by a curing reaction.

Details of a component forming the fifth transparent layer are as described in the section of the above-described first transparent transfer layer (except for the particles) in the transfer material. The particles incorporated in the fifth transparent layer are preferably particles imparting a low refractive index, more preferably inorganic oxide particles having a refractive index of less than 1.6, and still more preferably SiO₂ particles, or the like.

The touch sensor of the present disclosure preferably adopt an aspect in which the fourth transparent layer having a refractive index lower than a refractive index of the first transparent layer is disposed on the side of the first transparent layer opposite to the side in contact with the second transparent layer, and the fifth transparent layer having a refractive index lower than a refractive index of the third transparent layer is disposed on the side of the third transparent layer opposite to the side in contact with the second transparent layer, in addition to the first transparent layer, the second transparent layer, and the third transparent layer, from the viewpoint of further improving an electrode-pattern-covering property.

Furthermore, from the same viewpoint described above, the touch sensor of the present disclosure preferably has an aspect in which the first transparent layer has a refractive index of 1.65 to 1.8 and a thickness of 30 nm to 200 nm, the second transparent layer has a refractive index of 1.4 to 1.55 and a thickness of 1 μm to 10 μm, the third transparent layer has a refractive index of 1.65 to 1.8 and a thickness of 30 nm to 200 nm, the fourth transparent layer has a refractive index of 1.3 to 1.5 and a thickness of 10 nm to 100 nm, and the fifth transparent layer preferably has a refractive index of 1.3 to 1.5 and a thickness of 10 nm to 100 nm.

In this case, combining an aspect is more preferable, in which the sixth transparent layer has a refractive index of 1.6 to 1.7 and a thickness of 50 nm to 100 nm, and the seventh transparent layer has a refractive index of 1.6 to 1.7 and a thickness of 50 nm to 100 nm.

### Third Embodiment

Still another embodiment of the touch sensor of the present disclosure may be a third embodiment having the structure shown in FIG. 5. The third embodiment will be described with reference to FIG. 5. In a touch sensor according to the third embodiment, the same components as those of the touch sensor according to the first embodiment or the second embodiment are denoted by the same reference numerals, and the description of the components denoted by the same reference numerals is omitted.

That is, the touch sensor of the present disclosure preferably includes the sixth transparent layer, which has a refractive index that is higher than a refractive index of the base material on the substrate and is lower than a refractive index of the first electrode, between the base material on the substrate and the first electrode (the first electrode pattern). That is, it is preferable that the order of refractive indices be: the base material<the sixth transparent layer<the first electrode pattern. In the case where the sixth transparent layer is provided, a first-electrode-covering property is more effectively improved.

In addition, the touch sensor of the present disclosure preferably has the seventh transparent layer, which has a refractive index lower than a refractive index of the second electrode, on a surface of the second electrode (the second electrode pattern) opposite to the side on which the second transparent layer is disposed. That is, it is preferable that the order of refractive indices be: the seventh transparent layer<the second electrode pattern. In the case where the seventh transparent layer is provided, a second-electrode-covering property is more effectively improved.

Specifically, for example, as shown in FIG. 5, a touch sensor 500 of the third embodiment includes: a sixth transparent layer 41, which has a refractive index higher than a refractive index of a base material 60 on the substrate and lower than a refractive index of a first electrode 51, between the base material 60 on the substrate and the first electrode (the first electrode pattern) 51; and a seventh transparent layer 43, which has a refractive index lower than a refractive index of a second electrode 53, on a surface of the second electrode (the second electrode pattern) 53 opposite to the side on which a second transparent layer 33 is disposed.

Hereinafter, the sixth transparent layer 41 and the seventh transparent layer 43 will be described.

The sixth transparent layer 41 is a transparent layer which is disposed between the base material 60 on the substrate and the first electrode (the first electrode pattern) 51, and which has a refractive index higher than a refractive index of the base material 60 on the substrate and lower than a refractive index of the first electrode 51.

From the same reason described above, a refractive index of the sixth transparent layer is preferably 1.55 or more and less than 1.9, more preferably 1.6 to 1.7, and still more preferably 1.6 to 1.65.

A thickness of the sixth transparent layer is preferably 200 nm or less, more preferably 40 nm to 200 nm, and still more preferably 50 nm to 100 nm.

Among the values described above, the sixth transparent layer preferably has a refractive index of 1.6 to 1.7 and a thickness of 50 nm to 100 nm.

As shown in FIG. 5, since the sixth transparent layer is a layer disposed on the base material 60, and a laminate base material in which the sixth transparent layer is attached on the base material may be used as a base material of the touch sensor.

The thickness of the sixth transparent layer is an average thickness measured using a transmission electron microscope (TEM) and can be measured in the same manner as in the case of the first transparent layer.

A material for forming the sixth transparent layer is not limited as long as the sixth transparent layer has a refractive index that is higher than a refractive index of the base material on the substrate and is lower than a refractive index of the first electrode, and it is possible to use the same material as that used in the first transparent layer.

For the sixth transparent layer, a cured layer formed by a curing reaction of a curable component in the above-described first transparent transfer layer may be used.

For example, the sixth transparent layer may be a transfer layer disposed by transferring the above-described first transparent transfer layer of the transfer material onto the base material, or may be a layer formed by a curing reaction. The details of the components forming the sixth transparent layer are the same as the components of the first transparent transfer layer described above.

The seventh transparent layer 43 is a transparent layer which is disposed on a surface of the second electrode (the second electrode pattern) opposite to the side on which the second transparent layer is disposed, and which has a refractive index lower than a refractive index of the second electrode.

A refractive index of the seventh transparent layer is preferably 1.55 or more and less than 1.9, more preferably 1.6 to 1.7, and still more preferably 1.6 to 1.65.

A thickness of the seventh transparent layer is preferably 200 nm or less, more preferably 40 nm to 200 nm, and still more preferably 50 nm to 100 nm.

Among the values described above, the seventh transparent layer preferably has a refractive index of 1.6 to 1.7 and a thickness of 50 nm to 100 nm.

The thickness of the seventh transparent layer is an average thickness measured using a transmission electron microscope (TEM) and can be measured in the same manner as in the case of the first transparent layer.

A material for forming the seventh transparent layer is not limited as long as the seventh transparent layer is a layer having a refractive index lower than a refractive index of the second electrode, and it is possible to use the same material as that used in the first transparent layer. For the seventh transparent layer, a cured layer formed by a curing reaction of a curable component in the above-described first transparent transfer layer may be used.

For example, the seventh transparent layer may be a transfer layer disposed by transferring the above-described first transparent transfer layer of the transfer material onto the base material, or may be a layer formed by a curing reaction. The details of the components forming the seventh transparent layer are the same as the components of the first transparent transfer layer described above.

### Fourth Embodiment

Still another embodiment of the touch sensor of the present disclosure may be a fourth embodiment having the structure shown in FIG. 6. The fourth embodiment will be described with reference to FIG. 6. In a touch sensor according to the fourth embodiment, the same components as those of the touch sensor according to the first embodiment, the second embodiment, or the third embodiment are denoted by the same reference numerals, and the description of the components denoted by the same reference numerals is omitted.

That is, it is preferable that the touch sensor of the present disclosure adopt an aspect including, between a substrate having a base material and a first electrode pattern, and a second electrode pattern, the following transparent layers:

a second transparent layer that is disposed between a first electrode (the first electrode pattern) and a second electrode (the second electrode pattern), and has a thickness of 0.5 μm or more and less than 25 μm;

a first transparent layer that is disposed between the first electrode pattern and the second transparent layer, and has a refractive index higher than a refractive index of the second transparent layer;

a third transparent layer that is disposed between the second electrode pattern and the second transparent layer, and has a refractive index higher than a refractive index of the second transparent layer;

a fourth transparent layer that is disposed on a side of the first transparent layer opposite to the side in contact with the second transparent layer, and has a refractive index lower than a refractive index of the first transparent layer;

a fifth transparent layer that is disposed on a side of the third transparent layer opposite to the side in contact with the second transparent layer, and has a refractive index lower than a refractive index of the third transparent layer;

a sixth transparent layer that is disposed between the base material on the substrate and the first electrode, and has a refractive index higher than a refractive index of the base material on the substrate and lower than a refractive index of the first electrode; and

a seventh transparent layer that is disposed on a surface of the second electrode opposite to the side on which the second transparent layer is disposed, and has a refractive index lower than a refractive index of the second electrode pattern.

By adopting such a laminate structure, a first-electrode-pattern-covering property and a second-electrode-pattern-covering property become more excellent, and the effect of ameliorating visibility of electrode patterns is high.

As shown in FIGS. 3 to 6, in the touch sensor of the present disclosure, a transparent adhesive layer 70 may be further formed on the second electrode pattern or the seventh transparent layer. In addition, a glass substrate may be further disposed above the transparent adhesive layer 70 (on a side opposite to the side on which the second electrode pattern of the transparent adhesive layer 70 is disposed).

The transparent adhesive layer 70 may be a transparent layer having a refractive index of about 1.5 to 1.55.

<Method for Manufacturing Touch Sensor>

The touch sensor of the present disclosure can be produced by selecting any method as long as the method uses the transfer material.

The method for manufacturing a touch sensor of the present disclosure may adopt an aspect in which the first transparent layer, the second transparent layer, and the third transparent layer are sequentially transferred and formed using a transfer material having the first transparent transfer layer, a transfer material having the second transparent transfer layer, and a transfer material having the third transparent transfer layer in a case where the first transparent layer, the second transparent layer, and the third transparent layer are formed by a transfer method on a desired base material, specifically a substrate having the first electrode pattern thereon. In addition, the method for manufacturing a touch sensor of the present disclosure may adopt an aspect in which the first transparent layer, the second transparent layer, and the third transparent layer are collectively transferred and formed using a transfer material having the first transparent transfer layer, second transparent transfer layer, and third transparent transfer layer.

In the manufacturing method of the embodiment of the present disclosure, between both aspects, the aspect in which the first transparent layer, the second transparent layer, and the third transparent layer are collectively transferred using the transfer material having the first transparent transfer layer, second transparent transfer layer, and third transparent transfer layer is preferred, from the viewpoint of production efficiency.

Specifically, the touch sensor of the present disclosure is suitably produced by the above-described method using the transfer material of the present disclosure (the method for manufacturing a touch sensor of the present disclosure). That is, the touch sensor of the present disclosure is produced by a method including: forming the second transparent layer on the first electrode by transferring a transfer layer of a transfer material (hereinafter referred to as the second transparent-layer-forming step); forming the first transparent layer having a refractive index higher than a refractive index of the second transfer layer by transferring a transfer layer of a transfer material, between the first electrode and the second transparent layer (preferably, a surface of the second transparent layer between the first electrode and the second transparent layer) (hereinafter referred to as the first transparent-layer-forming step); forming the third transparent layer having a refractive index higher than a refractive index of the second transfer layer by transferring a transfer layer of a transfer material, on a side of the second transparent layer opposite to the side having the first transparent layer (a surface on a side of the second transparent layer opposite to the side having the first transparent layer) (hereinafter referred to as the third transparent-layer-forming step); and disposing the second electrode on a side of the third transparent layer opposite to the side having the second transparent layer.

The manufacturing method using the transfer material of the present disclosure may be a method including: disposing the first transparent transfer layer, the second transparent transfer layer, and the third transparent transfer layer on the first electrode by transferring a transfer layer of a transfer material; forming the first transparent layer, the second transparent layer, and the third transparent layer in this order from the side of the first electrode, on the first electrode (preferably vis exposure and development); and disposing the second electrode on a side of the third transparent layer opposite to the side having the second transparent layer.

In the present disclosure, by using a laminate structure in which the second transparent layer is sandwiched between the first transparent layer and the third transparent layer which have a refractive index higher than a refractive index of the second transparent layer, between the first electrode pattern and the second electrode pattern, an electrode-pattern-covering property becomes excellent, and visibility of electrode patterns is more effectively ameliorated.

Since each transparent layer is formed by a transfer method using a transfer material, a uniform thickness is ensured, a desired refractive index is easily and stably obtained, and adhesiveness is improved. Thereby, a touch sensor having an excellent electrode-pattern-covering property can be obtained.

Based on the above descriptions, the method for manufacturing a touch sensor of the present disclosure may be the following method including:
(i) using a temporary support, and a transfer material having a third transparent transfer layer, a second transparent transfer layer, and a first transparent transfer layer, which are sequentially laminated from the temporary support side; crimping on a transfer target; and peeling the temporary support off to collectively transfer the three layers.

Apart from the above method, the method for manufacturing a touch sensor of the present disclosure may be the following method including:
(ii) using a transfer material a having a laminate structure of a protective film/a third transparent transfer layer/a temporary support A in which the third transparent transfer layer is disposed on the temporary support A; and using a transfer material b having a laminate structure of a cover film/a first transparent transfer layer/a second transparent transfer layer/a temporary support B in which the second transparent transfer layer and the first transparent transfer layer are disposed on the temporary support B. That is, it is a method of preparing the transfer materials a and b; respectively peeling off the protective film of the transfer material a and the temporary support B of the transfer material b; using a transfer material c obtained by bringing the respective exposed surfaces into contact with each other, allowing them to overlap, and crimping them to further peel off the cover film; and collectively transferring the three layers to a transfer target. The transfer material c has a laminate structure of a temporary support A/a third transparent transfer layer/a second transparent transfer layer/a first transparent transfer layer/a cover film.

It is preferable that the method for producing a touch sensor of the present disclosure further include: transferring a transfer layer of a transfer material on a side of the first transparent layer opposite to a side in contact with the second transparent layer to form a third transparent layer having a refractive index higher than the refractive index of the second transparent layer (hereinafter referred to as the fourth transparent-layer-forming step); and transferring a transfer layer of a transfer material on a side of the third transparent layer opposite to a side in contact with the second transparent layer to form a fifth transparent layer having a refractive index higher than a refractive index of the third transparent layer (hereinafter referred to as the fifth transparent-layer-forming step).

In this case, the method for manufacturing a touch sensor of the present disclosure is preferably the following method including:

using a temporary support, and a transfer material having a fifth transparent transfer layer, a third transparent transfer layer, a second transparent transfer layer, a first transparent transfer layer, and a fourth transparent transfer layer, which are sequentially laminated from the temporary support side.

In the fourth transparent-layer-forming step, the fourth transparent layer can be transferred and formed in the same manner as in the first transparent-layer-forming step by appropriately selecting particles and the like so as to obtain a desired refractive index.

In addition, in the fifth transparent-layer-forming step, the fifth transparent layer can be transferred and formed in the same manner as in the first transparent-layer-forming step by appropriately selecting particles and the like so as to obtain a desired refractive index.

In addition, as shown in FIGS. 3 to 6, the method for manufacturing a touch sensor of the present disclosure may further include a step of forming a transparent adhesive layer on the second electrode pattern or the seventh transparent layer.

After transferring the respective transparent layers to a transfer target as described above, the respective transparent layers are exposed in a pattern to be subjected a development process, and thereby a desired pattern can be formed.

A method for exposing a material for forming a layer in a pattern shape is not particularly limited, and the material may be exposed by surface exposure in which a photomask is used or may be exposed by scanning and exposing the material using laser beams or the like. In addition, the material may be exposed by refraction-type exposure in which a lens is used or may be exposed by reflection-type exposure in which a reflection mirror is used. In addition, the material may be exposed using an exposure method such as contact exposure, proximity exposure, reduced projection exposure, or reflection projection exposure. A light source is preferably a g ray, an h ray, an i ray, a j ray, or the like. As the kind of the light sources, for example, a metal halide lamp, a high-pressure mercury lamp, and a light emitting diode (LED) are exemplified.

In addition, the development after exposure is not particularly limited, and it is preferable to use an alkali developer

<Image Display Device>

The image display device of the embodiment of the present disclosure includes the above-described touch sensor of the embodiment of the present disclosure. Therefore, the visibility of patterns derived from internal electrode wires in an image display portion of the image display device is ameliorated, and a favorable display screen in terms of appearance is formed.

The image display device is a display device including a touch panel such as an electrostatic capacitance-type input device, and examples thereof include an organic electroluminescence (EL) display device, a liquid crystal display device, and the like.

### EXAMPLES

Hereinafter, the embodiment of the present invention will be more specifically described using examples. However, the embodiment of the present invention is not limited to the following examples within the scope of the gist of the present invention. Unless particularly otherwise described, “parts” and “%” are mass-based.

Compositional ratios in a polymer are molar ratios unless particularly otherwise described.

In addition, unless particularly otherwise described, refractive indexes are values measured using an ellipsometer at a wavelength of 550 nm.

In addition, in examples described below, the weight-average molecular weight (Mw) and number average molecular weight (Mn) of a resin were measured by gel permeation chromatography (GPC) under the following conditions. A calibration curve was produced from “standard specimen TSK standard, polystyrene” manufactured by Tosoh Corporation: eight samples of “F-40,” “F-20,” “F-4,” “F-1,” “A-5000,” “A-2500,” “A-1000,” and “n-propylbenzene.”

<Conditions>

GPC: HLC (registered trademark)-8020GPC (manufactured by Tosoh Corporation)

Column: Three TSKgel (registered trademark), Super Multipore HZ-H (manufactured by Tosoh Corporation, 4.6 mmID×15 cm)

Eluent: Tetrahydrofuran (THF)

Specimen concentration: 0.45% by mass

Flow rate: 0.35 ml/min

Sample injection amount: 10 μl

Measurement temperature: 40° C.

Detector: Differential refractometer (RI)

<Preparation of Coating Fluids for Forming Transparent Transfer Layer>

Materials which are coating fluids for forming a first transparent transfer layer, a second transparent transfer layer, a third transparent transfer layer, a fourth transparent transfer layer, and a fifth transparent transfer layer were prepared according to the components and contents in the compositions shown in Tables 1 to 3.

TABLE 1

| | | Material | Material | Material |
|---|---|---|---|---|
| | Material | A-1 | A-2 | A-3 |
| Particle | Zirconia dispersion liquid: ZR-010 | — | 9.37 | — |
| | (manufactured by SOLAR CO., LTD.) | | | |
| | Colloidal silica sol: MEK-ST-40 | — | — | 9.67 |
| | (manufactured by Nissan Chemical | | | |
| | Industries, Ltd.) | | | |
| Photopolymerizable | Tricyclodecane dimethanol diacrylate | 5.60 | — | 1.12 |
| compound | (A-DCP, manufactured by Shin- | | | |
| | Nakamura Chemical Co., Ltd.) | | | |
| | Carboxylic-acid-containing monomer | 0.93 | 5.50 | 0.19 |
| | ARONIX TO-2349 (manufactured by | | | |
| | TOAGOSEI CO., LTD.) | | | |
| | Urethane acrylate, 8UX-015A | 2.80 | — | 0.56 |
| | (manufactured by Taisei Fine | | | |
| | Chemical Co., Ltd.) | | | |
| Binder polymer | Compound A | 15.59 | — | 3.33 |
| | (Acid level: 95 mg KOH/g, Mw: | | | |
| | 29000, Mn: 13700) | | | |
| Photopolymerization | Ethanone, 1-[9-ethyl-6-(2- | 0.11 | — | — |
| initiator | methylbenzoyl)-9H- | | | |
| | carbazole-3-yl]-,1- | | | |
| | (O-acetyloxime) (OXE-02, | | | |
| | manufactured by BASF) | | | |
| | 2-Methyl-1-(4-methyl | 0.21 | — | — |
| | thiophenyl)-2-morpholinopropan- | | | |
| | 1-one (Irgacure 907, | | | |
| | manufactured by BASF) | | | |
| | 2-Benzyl-2-dimethylamino-1-(4- | — | 0.12 | 0.12 |
| | morpholinophenyl)butanone | | | |
| | (Irgacure 379, manufactured | | | |
| | by BASF) | | | |
| | KAYACURE DETX-S | — | 0.12 | 0.12 |
| | (manufactured by Nippon Kayaku | | | |
| | Co., Ltd.) | | | |
| Sensitizer | N-phenylglycine | 0.03 | 0.01 | 0.01 |
| | (manufactured by YODO KAGAKU | | | |
| | CO., LTD) | | | |
| Blocked isocyanate | AOI-BM | 3.63 | — | — |
| | (manufactured by Showa | | | |
| | Denko K.K.) | | | |
| Additive | MEGAFACE F551 | 0.02 | 0.01 | 0.01 |
| | (manufactured by DIC Corporation) | | | |
| | 1,2,4-Triazole | 0.09 | 0.03 | 0.03 |
| | (manufactured by Otsuka Chemical | | | |
| | Co., Ltd.) | | | |
| Solvent | 1-Methoxy-2-propyl acetate | 31.08 | 30.00 | 30.00 |
| | Methyl ethyl ketone | 40.00 | 54.94 | 54.94 |

| | | | |
|---|---|---|---|
| Total (parts by mass) | 100 | 100 | 100 |

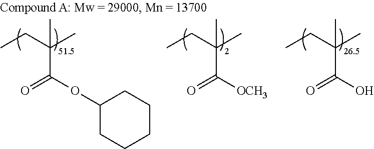

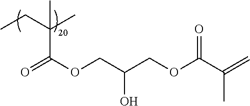

TABLE 21

| | | Material | Material | Material | Material | Material |
|---|---|---|---|---|---|---|
| Material | | B-1 | B-2 | B-3 | B-4 | B-5 |
| NANOUSE OZ-S30M: methanol dispersion | | 4.34 | 4.70 | — | 3.80 | — |
| liquid of ZrO₂ particles (non-volatile content: | | | | | | |
| 30.5%), manufactured by Nissan Chemical | | | | | | |
| Industries, Ltd. | | | | | | |
| Colloidal silica: SNOWTEX ST-N (non-volatile | | — | — | 3.00 | — | — |
| content: 20%), manufactured by Nissan | | | | | | |
| Chemical Industries, Ltd. | | | | | | |
| TS-020: water dispersion liquid of TiO₂ | | — | — | — | — | 4.34 |
| particles (non-volatile content: 25.6%), | | | | | | |
| manufactured by TAYCA CORPORATION | | | | | | |
| Ammonia water (25%) | | 7.82 | 7.82 | 2.90 | 7.82 | 7.82 |
| Monoisopropanolamine | | 0.02 | 0.02 | 0.02 | 0.02 | 0.02 |
| (manufactured by MITSUI FINE | | | | | | |
| CHEMICALS, INC.) | | | | | | |
| Binder | Copolymer resin of methacrylic | 0.24 | 0.13 | 0.44 | 0.40 | 0.25 |
| polymer | acid/allyl methacrylate | | | | | |
| | (Mw: 38000, Mn: 8500, | | | | | |
| | composition ratio = 40/60 | | | | | |
| | (percentage)) | | | | | |
| | Compound B (Mw: 15500) | 0.01 | 0.01 | 0.01 | 0.01 | 0.01 |

| | | | | | |
|---|---|---|---|---|---|
| Carboxylic-acid-containing monomer | 0.03 | 0.03 | 0.03 | 0.03 | 0.03 |
| ARONIX TO-2349 (manufactured by | | | | | |
| TOAGOSEI CO., LTD.) | | | | | |
| Benzotriazole BT-LX (manufactured by | 0.03 | 0.03 | 0.03 | 0.03 | 0.03 |
| JOHOKU CHEMICAL CO., LTD.) | | | | | |
| MEGAFACE F444 | 0.01 | 0.01 | 0.01 | 0.01 | 0.01 |
| (manufactured by DIC Corporation) | | | | | |
| Ion-exchanged water | 21.5 | 19.2 | 33.6 | 19.9 | 24.5 |
| Methanol | 66.0 | 68.0 | 60.0 | 68.0 | 63.0 |
| Total (parts by mass) | 100 | 100 | 100 | 100 | 100 |

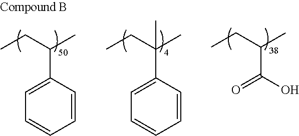

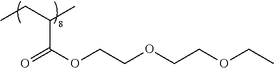

TABLE 3

| | Material | Material | Material | Material | Material |
|---|---|---|---|---|---|
| Material | C-1 | C-2 | C-3 | C-4 | C-5 |
| NANOUSE OZ-S30M: methanol dispersion | 4.34 | 4.70 | 3.80 | — | — |
| liquid of ZrO₂ particles (non-volatile content: | | | | | |
| 30.5%), manufactured by Nissan Chemical | | | | | |
| Industries, Ltd. | | | | | |
| Colloidal silica: SNOWTEX ST-N (non-volatile | — | — | — | — | 3.00 |
| content: 20%), (manufactured by Nissan | | | | | |
| Chemical Industries, Ltd.) | | | | | |
| TS-020: water dispersion liquid of TiO₂ | — | — | — | 4.34 | — |
| particles (non-volatile content: 25.6%), | | | | | |
| manufactured by TAYCA CORPORATION | | | | | |
| Compound C (modified polyvinyl alcohol, | 0.24 | 0.13 | 0.40 | 0.25 | 0.44 |
| degree of polymerization: 200) | | | | | |
| Benzotriazole BT-LX (manufactured by | 0.03 | 0.03 | 0.03 | 0.03 | 0.03 |
| JOHOKU CHEMICAL CO., LTD.) | | | | | |
| MEGAFACE F444 | 0.01 | 0.01 | 0.01 | 0.01 | 0.01 |
| (manufactured by DIC Corporation) | | | | | |
| Ion-exchanged water | 45.4 | 45.1 | 27.8 | 32.4 | 33.5 |
| Methanol | 50.0 | 50.0 | 68.0 | 63.0 | 63.0 |
| Total (parts by mass) | 100 | 100 | 100 | 100 | 100 |

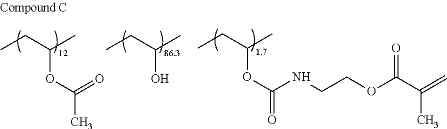

<Production of Transfer Film>

### Transfer Film 1 (Example 1)

Material A-2 for forming a third transparent transfer layer was applied onto a temporary support that was a 16 μm-thick polyethylene terephthalate film using a slit-shaped nozzle at an application amount adjusted to obtain a thickness after drying of 70 nm, and a solvent was volatilized in a drying zone (80° C.), thereby forming a third transparent transfer layer. Next, a 16 μm-thick polyethylene terephthalate film was attached by pressure to a surface of the third transparent transfer layer as a protective film.

A transfer film 1a having a laminate structure of the protective film/the third transparent transfer layer/the temporary support was produced in the above-described manner.

Next, Material A-1 for forming a second transparent transfer layer was applied onto a temporary support that was a 16 μm-thick polyethylene terephthalate film using a slit-shaped nozzle at an application amount adjusted to obtain a thickness after drying of 8.0 μm, and a solvent was volatilized in a drying zone (80° C.), thereby forming a second transparent transfer layer. Subsequently, Material B-1 for forming a first transparent transfer layer was applied onto the dried second transparent transfer layer using a slit-shaped nozzle at an application amount adjusted to obtain a thickness after drying of 70 nm. After that, the applied film was dried at a drying temperature of 70° C., thereby forming a first transparent transfer layer. Next, a 16 μm-thick polyethylene terephthalate film was attached by pressure to a surface of the first transparent transfer layer as a cover film.

A transfer film 1b having a laminate structure of the cover film/the first transparent transfer layer/the second transparent transfer layer/the temporary support was produced in the above-described manner.

Next, the protective film of the transfer film 1a was peeled off, and the temporary support of the transfer film 1b was peeled off. Then, the surface of the third transparent transfer layer, which was the exposed surface of the transfer film 1a, was brought into contact with the surface of the second transparent transfer layer, which was the exposed surface of the transfer film 1b, and pressed.

In the above-described manner, a transfer film 1 (transfer material) having a laminate structure of the temporary support/the third transparent transfer layer/the second transparent transfer layer/the first transparent transfer layer/the cover film was produced. The transfer film 1 has the laminate structure shown in FIG. 1.

### Transfer Films 2 to 7 (Examples 2, 4, and 6 to 10)

Material C-1 for forming a third transparent transfer layer was applied onto a temporary support that was a 16 μm-thick polyethylene terephthalate film using a slit-shaped nozzle at an application amount adjusted to obtain a thickness after drying of 70 nm, and a solvent was volatilized in a drying zone (80° C.), thereby forming a third transparent transfer layer.

Next, Material A-1 for forming a second transparent transfer layer was applied onto the dried third transparent transfer layer using a slit-shaped nozzle at an application amount adjusted to obtain a thickness after drying of 8.0 μm. After that, the applied film was dried at a drying temperature of 80° C., thereby forming a second transparent transfer layer.

Next, Material B-1 for forming a first transparent transfer layer was applied onto the dried second transparent transfer layer using a slit-shaped nozzle at an application amount adjusted to obtain a thickness after drying of 70 nm. After that, the applied film was dried at a drying temperature of 70° C., thereby forming a first transparent transfer layer.

Next, a 16 μm-thick polyethylene terephthalate film was attached by pressure to a surface of the first transparent transfer layer as a protective film.

In the above-described manner, a transfer film 2 (transfer material) having a laminate structure of the protective film/the first transparent transfer layer/the second transparent transfer layer/the third transparent transfer layer/the temporary support was produced as shown in FIG. 1.

In addition, transfer films 3 and 4 (transfer materials) were produced in the same manner as in the transfer film 2 except that Material B-1 for forming a first transparent transfer layer used for forming the first transparent layer was replaced with Material B-4 or B-5, Material C-1 for forming a third transparent transfer layer was replaced with Material C-3 or C-4, and each thickness was changed as shown in Table 5 in the production of the transfer film 2 as shown in Table 5.

Furthermore, transfer films 5 to 7 (transfer materials) were produced in the same manner as the transfer film 2 except that the thickness of the second transparent layer was changed from 8.0 μm to a thickness shown in Table 5 in the production of the transfer film 2 described above.

### Transfer Film 8 (Examples 3 and 5)

Material A-3 for forming a fifth transparent transfer layer was applied onto a temporary support that was a 16 μm-thick polyethylene terephthalate film using a slit-shaped nozzle at an application amount adjusted to obtain a thickness after drying of 33 nm, and a solvent was volatilized in a drying zone (80° C.), thereby forming a fifth transparent transfer layer.

Next, Material C-2 for forming a third transparent transfer layer was applied onto the dried fifth transparent transfer layer using a slit-shaped nozzle at an application amount adjusted to obtain a thickness after drying of 35 nm. After that, the applied film was dried at a drying temperature of 80° C., thereby forming a third transparent transfer layer.

Next, Material A-1 for forming a second transparent transfer layer was applied onto the dried third transparent transfer layer using a slit-shaped nozzle at an application amount adjusted to obtain a thickness after drying of 8.0 μm. After that, the applied film was dried at a drying temperature of 80° C., thereby forming a second transparent transfer layer.

Next, Material B-2 for forming a first transparent transfer layer was applied onto the dried second transparent transfer layer using a slit-shaped nozzle at an application amount adjusted to obtain a thickness after drying of 35 nm. After that, the applied film was dried at a drying temperature of 70° C., thereby forming a first transparent transfer layer.

Furthermore, Material B-3 for forming a fourth transparent transfer layer was applied onto the dried first transparent transfer layer using a slit-shaped nozzle at an application amount adjusted to obtain a thickness after drying of 33 nm. After that, the applied film was dried at a drying temperature of 70° C., thereby forming a fourth transparent transfer layer.

Next, a 16 μm-thick polyethylene terephthalate film was attached by pressure to a surface of the dried fourth transparent transfer layer as a protective film.

In the above-described manner, a transfer film 8 (transfer material) having a laminate structure of the protective film/the fourth transparent transfer layer/the first transparent transfer layer/the second transparent transfer layer/the third transparent transfer layer/the fifth transparent transfer layer/the temporary support was produced as shown in FIG. 2.

### Transfer Film 9 (Comparative Example 1)

Material A-1 for forming the second transparent transfer layer was applied onto a temporary support that was a 16 μm-thick polyethylene terephthalate film using a slit-shaped nozzle at an application amount adjusted to obtain a thickness after drying of 8.0 μm. Thereafter, a solvent was volatilized in a drying zone (80° C.), thereby forming a second transparent transfer layer. Next, a 16 μm-thick polyethylene terephthalate film was attached by pressure to a surface of the second transparent transfer layer as a protective film.

A comparative transfer film 9 (transfer material) having a laminate structure of the protective film/the second transparent transfer layer/the temporary support was produced in the above-described manner.

### Transfer Film 10 (Comparative Example 2)

A comparative transfer film 10 (transfer material) having a laminate structure of the protective film/the first transparent transfer layer/the second transparent transfer layer/the third transparent transfer layer/the temporary support was produced in the same manner as in the transfer film 2 except that Material B-1 for forming a first transparent transfer layer used for forming the first transparent layer was replaced with Material B-3, and Material C-1 for forming a third transparent transfer layer was replaced with Material C-5.

<Production of Film Attached with Transparent Electrode Pattern>

### (Formation of Transparent Film Substrate)

A corona discharge treatment was carried out on a cycloolefin resin film (base material) having a film thickness of 38 μm and a refractive index of 1.53 using a high-frequency oscillator for three seconds under the following conditions to modify a surface, thereby producing a transparent film substrate.

The transparent film substrate was a substrate used in Examples 1 to 3 and Comparative Examples 1 and 2 to be described later.

<Conditions>

Output voltage: 100%

Output: 250 W

Electrode: wire electrode having a diameter of 1.2 mm

Electrode length: 240 mm

Distance between work electrodes: 1.5 mm

(Formation of Transparent-Film-Attached Substrate)

Separately from the above, Material-D shown in Table 4 was applied to the corona discharge treatment surface of the transparent film substrate produced in the same manner as above using a slit-shaped nozzle, and the surface was irradiated with ultraviolet rays (integrated light quantity: 300 mJ/cm²) and dried at about 110° C. Thereby, a transparent-film-attached substrate having a sixth transparent layer having a refractive index of 1.60 and a film thickness of 80 nm on the transparent film substrate was produced.

The transparent-film-attached substrate was a substrate used in Examples 4 to 10 to be described later.

TABLE 4

| Material | Material - D |
|---|---|
| ZrO₂: ZR-010 manufactured by SOLAR CO., LTD. | 2.08 |
| DPHA solution (dipentaerythritol hexa-acrylate: 38%, dipentaerythritol | 0.29 |
| penta-acrylate: 38%, 1-methoxy-2-propyl acetate: 24%) | |
| Urethane monomer: UK OLIGO UA-32P, manufactured by Shin-Nakamura | 0.14 |
| Chemical Co., Ltd.: non-volatile content 75%, 1-methoxy-2-propyl | |
| acetate 25% | |
| Monomer mixture (polymerizable compound (b2-1) described in paragraph | 0.36 |
| [0111] of JP2012-078528A, n = 1: tripentaerythritol octacrylate content | |
| 85%, total of n = 2 and n = 3 as impurities 15%) | |
| Polymer solution 1 (Structural Formula P-25 described in paragraph [0058] | 1.89 |
| of JP2008-146018A: weight-average molecular weight = 35000, solid | |
| contents 45%, 1-methoxy-2-propyl acetate 15%, 1-methoxy-2- | |
| propyl 40%) | |
| Photoradical polymerization initiator: | 0.03 |
| 2-benzyl-2-dimethylamino-1-(4-morpholinophenyl)-butanone (Irgacure | |
| (trade name) 379, manufactured by BASF) | |
| Photopolymerization initiator: (KAYACURE DETX-S (alkylthioxanthone, | 0.03 |
| Nippon Kayaku Co., Ltd.) | |
| Polymer solution 2 (polymer of structural formula represented by Formula | 0.01 |
| (3): solution with weight-average molecular weight of 15000, non-volatile | |
| content 30% by mass, methyl ethyl ketone 70% by mass) | |
| 1-Methoxy-2-propyl acetate | 38.73 |
| Methyl ethyl ketone | 56.80 |
| Total(parts by mass) | 100 |

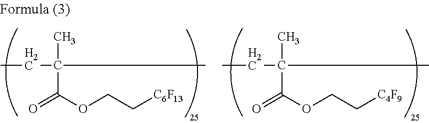

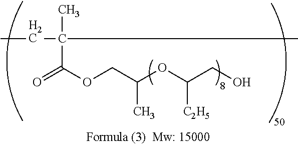

<Formation of Transparent Electrode Pattern>

The above-described transparent film substrate or transparent-film-attached substrate was introduced into a vacuum chamber, and an ITO film having a thickness of 40 nm and a refractive index of 1.82 was formed as a transparent electrode layer by direct current (DC) magnetron sputtering (conditions: the temperature of the transparent film substrate 10: 150° C., argon pressure: 0.13 Pa, and oxygen pressure: 0.01 Pa) using an ITO target (indium:tin-95:5 (molar ratio)) having a tin oxide (SnO₂) content ratio of 10% by mass.

Thereby, a substrate in which the transparent ITO film was disposed on the transparent film substrate, and a substrate in which the sixth transparent layer and the transparent ITO film were disposed on the transparent-film-attached substrate were obtained. The ITO film had a surface resistance value of 80Ω/□ (Ω per square) and a refractive index of 1.9.

Next, the ITO film was patterned by etching the ITO film using a well-known chemical etching method. Thereby, a film 1 attached with transparent electrode patterns which has the patterned first transparent electrode (the first electrode; hereinafter, the first electrode pattern) on the transparent film substrate, and a film 2 attached with transparent electrode patterns which has the patterned first transparent electrode (the first electrode pattern) on the sixth transparent layer of the transparent-film-attached substrate were produced.

Next, as shown in Table 5, touch sensors were produced using the transfer films 1 to 10 and the films 1 and 2 attached with transparent electrode patterns.

### Examples 1 to 10 and Comparative Examples 1 and 2

—Production of Touch Sensor—

The protective films (or cover films) of the transfer films 1 to 10 produced above were respectively peeled off. The exposed surfaces of the transfer films 1 to 10 exposed by the peeling were brought into contact with the corona discharge treatment surface including the transparent electrode patterns of the film 1 attached with transparent electrode patterns, or the surface of the sixth transparent layer including the transparent electrode patterns of the film 2 attached with transparent electrode patterns, and laminated under the following conditions. Thereby, 12 types of transparent laminates were obtained.

<Conditions>

Temperature of transparent film substrate: 40° C.

Temperature of rubber roller: 90° C.

Linear pressure: 3 N/cm

Transportation rate: 4 m/min

Next, the distance between a surface of an exposure mask (mask for forming through-holes) and a surface of the temporary support of the transparent laminate was set to 125 μm, and the transparent laminate was exposed via the temporary support in a pattern shape using a proximity-type stepper having a ultrahigh-pressure mercury lamp (Hitachi High-Tech Electronics Engineering Co., Ltd.) at an exposure amount of an i ray being 100 mJ/cm².

After that, the temporary support was peeled off from the transparent laminate, and the peeled surface was washed for 60 seconds using a sodium carbonate 1% by mass aqueous solution (temperature: 32° C.). Ultrapure water was further sprayed to the peeled surface from an ultrahigh-pressure washing nozzle, thereby removing a residue. Subsequently, air was blown to the peeled surface to remove moisture, and a post baking treatment was carried out at a temperature of 145° C. for 30 minutes.

Next, an ITO film having a thickness of 40 nm and a refractive index of 1.82 was formed by direct current (DC) magnetron sputtering (conditions: the temperature of the transparent film substrate 10: 150° C., argon pressure: 0.13 Pa, and oxygen pressure: 0.01 Pa) using an ITO target (indium:tin-95:5 (molar ratio)) having a tin oxide (SnO₂) content ratio of 10% by mass. The ITO film had a surface resistance value of 80/D (f per square) and a refractive index of 1.9.

Next, the ITO film was patterned by etching it using a well-known chemical etching method, and a patterned transparent electrode (the second electrode; hereinafter, the second electrode pattern) was formed on the peeled surfaces of the respective transparent laminates.

In Examples 1 and 2, and Comparative Example 2, a touch sensor having a laminate structure shown in FIG. 3 was produced in the above-described manner. In addition, in Example 3, a touch sensor having a laminate structure shown in FIG. 4 was produced in the above-described manner.

Furthermore, in Examples 4 to 10, Material-D described above was further applied onto the second transparent electrode pattern formed on the peeled surfaces of the respective transparent laminates using a slit-shaped nozzle. After that, the applied film was irradiated with ultraviolet rays (integrated light quantity: 300 mJ/cm²) and dried at approximately 110° C. Thereby, a seventh transparent layer having a refractive index of 1.60 and a thickness of 80 nm was formed.

In Examples 4 and 6 to 10, a touch sensor having a laminate structure shown in FIG. 5 was produced in the above-described manner. In addition, in Example 5, a touch sensor having a laminate structure shown in FIG. 6 was produced in the above-described manner.

—Evaluation 1—

(1) Covering Property for Transparent Electrode Patterns

As described above, a black polyethylene terephthalate (PET) material was adhered to the transparent film substrate of the 12 types of transparent laminates in which each of the transfer films 1 to 10 was brought into contact with the film 1 attached with transparent electrode patterns or the film 2 attached with transparent electrode patterns, and the entire substrate was shielded from light. The adhesion of the black PET material was performed using a transparent adhesive tape (trade name: OCA tape 8171CL, manufactured by 3M Japan Ltd.).

In the dark room, light of the fluorescent lamp was applied from the surface of the temporary support disposed on the side opposite to the side on which the black PET material of the transparent laminate was adhered, reflected light from the temporary support was visually observed obliquely, and the appearance of the transparent electrode patterns was evaluated according to the following evaluation standard. In the evaluation standard, A, B, and C are in a practically permissible range, A or B is preferred, and A is more preferred. Evaluation results are shown in Table 5.

<Evaluation Standard>

A: The electrode pattern was not visible in the case of carefully observing it from a position 15 cm away from the laminate, and the electrode pattern was not visible also in the case of normally viewing it from a position 40 cm away from the laminate.

B: The electrode pattern was slightly visible in the case of carefully observing it from a position 15 cm away from the laminate, but the electrode pattern was not visible in the case of normally viewing it from a position 40 cm away from the laminate.

C: The electrode pattern was slightly visible even in the case of carefully observing it from a position 15 cm away from the laminate, and the electrode pattern was also slightly visible in the case of normally viewing it from a position 40 cm away from the laminate.

D: The electrode pattern was clearly visible in the case of carefully observing it from a position 15 cm away from the laminate, and the electrode pattern was slightly visible in the case of normally viewing it from a position 40 cm away from the laminate.

E: The electrode pattern was clearly visible in the case of carefully observing it from a position 15 cm away from the laminate, and the electrode pattern was also clearly visible in the case of normally viewing it from a position 40 cm away from the laminate.

(2) Reflectivity

In the same manner as in the evaluation of “Covering property for transparent electrode patterns” described above, a transparent laminate on which a black PET material was adhered was prepared, and reflectivity of the transparent laminate with respect to a D65 light source was measured using a spectrophotometer V-570 (manufactured by JASCO Corporation). The measurement results are shown in Table 5.

TABLE 5

| | | Sixth | | Fourth | | | First | | | Second | | | |
|---|---|---|---|---|---|---|---|---|---|---|---|---|---|
| | | transparent | | transparent | | | transparent | | | transparent | | | |
| | | layer | | layer | | | layer | | | layer | | | |
| | Transfer | Refractive | Thick- | Mate- | Refractive | Thick- | Mate- | Refractive | Thick- | Mate- | Refractive | Thick- | |
| | film No. | index | ness | rial | index | ness | rial | index | ness | rial | index | ness | |
| Example 1 | 1 | — | — | — | — | — | Mate- | 1.68 | 70 nm | Mate- | 1.51 | 8 | μm |
| | | | | | | | rial | | | rial | | | |
| | | | | | | | B-1 | | | A-1 | | | |
| Example 2 | 2 | — | — | — | — | — | Mate- | 1.68 | 70 nm | Mate- | 1.51 | 8 | μm |
| | | | | | | | rial | | | rial | | | |
| | | | | | | | B-1 | | | A-1 | | | |
| Example 3 | 8 | — | — | Mate- | 1.48 | 33 nm | Mate- | 1.70 | 35 nm | Mate- | 1.51 | 8 | μm |
| | | | | rial | | | rial | | | rial | | | |
| | | | | B-3 | | | B-2 | | | A-1 | | | |
| Example 4 | 2 | 1.60 | 80 nm | — | — | — | Mate- | 1.68 | 70 nm | Mate- | 1.51 | 8 | μm |
| | | | | | | | rial | | | rial | | | |
| | | | | | | | B-1 | | | A-1 | | | |
| Example 5 | 8 | 1.60 | 80 nm | Mate- | 1.48 | 33 nm | Mate- | 1.70 | 35 nm | Mate- | 1.51 | 8 | μm |
| | | | | rial | | | rial | | | rial | | | |
| | | | | B-3 | | | B-2 | | | A-1 | | | |
| Example 6 | 3 | 1.60 | 80 nm | — | — | — | Mate- | 1.60 | 80 nm | Mate- | 1.51 | 8 | μm |
| | | | | | | | rial | | | rial | | | |
| | | | | | | | B-4 | | | A-1 | | | |
| Example 7 | 4 | 1.60 | 80 nm | — | — | — | Mate- | 1.80 | 60 nm | Mate- | 1.51 | 8 | μm |
| | | | | | | | rial | | | rial | | | |
| | | | | | | | B-5 | | | A-1 | | | |
| Example 8 | 5 | 1.60 | 80 nm | — | — | — | Mate- | 1.68 | 70 nm | Mate- | 1.51 | 1 | μm |
| | | | | | | | rial | | | rial | | | |
| | | | | | | | B-1 | | | A-1 | | | |
| Example 9 | 6 | 1.60 | 80 nm | — | — | — | Mate- | 1.68 | 70 nm | Mate- | 1.51 | 15 | μm |
| | | | | | | | rial | | | rial | | | |
| | | | | | | | B-1 | | | A-1 | | | |
| Example 10 | 7 | 1.60 | 80 nm | — | — | — | Mate- | 1.68 | 70 nm | Mate- | 1.51 | 30 | μm |
| | | | | | | | rial | | | rial | | | |
| | | | | | | | B-1 | | | A-1 | | | |
| Comparative | 9 | — | — | — | — | — | — | — | — | Mate- | 1.51 | 8 | μm |
| Example 1 | | | | | | | | | | rial | | | |
| | | | | | | | | | | A-1 | | | |
| Comparative | 10 | — | — | — | — | — | Mate- | 1.48 | 70 nm | Mate- | 1.51 | 8 | μm |
| Example 2 | | | | | | | rial | | | rial | | | |
| | | | | | | | B-3 | | | A-1 | | | |

| | Third | | | Fifth | | | Seventh | | | | |
|---|---|---|---|---|---|---|---|---|---|---|---|
| | transparent | | | transparent | | | transparent | | | | |
| | layer | | | layer | | | layer | | Evaluation | | |
| | Mate- | Refractive | Thick- | Mate- | Refractive | Thick- | Refractive | Thick- | Reflec- | Covering | |
| | rial | index | ness | rial | index | ness | index | ness | tance | property | Note |
| Example 1 | Mate- | 1.68 | 70 nm | — | — | — | — | — | 2.00% | C | Adhesion |
| | rial | | | | | | | | | | |
| | A-2 | | | | | | | | | | |
| Example 2 | Mate- | 1.68 | 70 nm | — | — | — | — | — | 2.00% | C | Sequential |
| | rial | | | | | | | | | | lamination |
| | C-1 | | | | | | | | | | |
| Example 3 | Mate- | 1.70 | 35 nm | Mate- | 1.48 | 33 nm | — | — | 1.60% | B | Sequential |
| | rial | | | rial | | | | | | | lamination |
| | C-2 | | | A-3 | | | | | | | |
| Example 4 | Mate- | 1.68 | 70 nm | — | — | — | 1.60 | 80 nm | 1.30% | B | Sequential |
| | rial | | | | | | | | | | lamination |
| | C-1 | | | | | | | | | | |
| Example 5 | Mate- | 1.70 | 35 nm | Mate- | 1.48 | 33 nm | 1.60 | 80 nm | 1.20% | A | Sequential |
| | rial | | | rial | | | | | | | lamination |
| | C-2 | | | A-3 | | | | | | | |
| Example 6 | Mate- | 1.60 | 80 nm | — | — | — | 1.60 | 80 nm | 1.50% | B | Sequential |
| | rial | | | | | | | | | | lamination |
| | C-3 | | | | | | | | | | |
| Example 7 | Mate- | 1.80 | 60 nm | — | — | — | 1.60 | 80 nm | 1.50% | B | Sequential |
| | rial | | | | | | | | | | lamination |
| | C-4 | | | | | | | | | | |
| Example 8 | Mate- | 1.68 | 70 nm | — | — | — | 1.60 | 80 nm | 1.30% | B | Sequential |
| | rial | | | | | | | | | | lamination |
| | C-1 | | | | | | | | | | |
| Example 9 | Mate- | 1.68 | 70 nm | — | — | — | 1.60 | 80 nm | 1.30% | B | Sequential |
| | rial | | | | | | | | | | lamination |
| | C-1 | | | | | | | | | | |
| Example 10 | Mate- | 1.68 | 70 nm | — | — | — | 1.60 | 80 nm | 1.30% | B | Sequential |
| | rial | | | | | | | | | | lamination |
| | C-1 | | | | | | | | | | |
| Comparative | — | — | — | — | — | — | — | — | 4.00% | E | Sequential |
| Example 1 | | | | | | | | | | | lamination |
| Comparative | Mate- | 1.48 | 70 nm | — | — | — | — | — | 4.00% | E | Sequential |
| Example 2 | rial | | | | | | | | | | lamination |
| | C-5 | | | | | | | | | | |

As shown in Table 5, the effect of reducing reflectivity was remarkably exhibited, and the electrode-pattern-covering property was significantly improved in the touch sensors of the examples in which the first transparent layer and the third transparent layer having refractive indexes higher than the refractive index of the second transparent layer were laminated on both sides of the second transparent layer by sandwiching the second transparent layer therebetween, as compared to the touch sensor of Comparative Example 1 having a single-layer structure, and the touch sensor of Comparative Example 2 in which the refractive index of the second transparent layer was higher than the refractive indexes of the first transparent layer and the third transparent layer.

In addition, as compared with Examples 1 and 2, reflectivity was further reduced, the electrode-pattern-covering property was excellent, and the visibility of electrode patterns was further ameliorated in the touch sensor of Example 3 which had the laminate structure including the fourth transparent layer having the refractive index lower than the refractive index of the first transparent layer, and the fifth transparent layer having the refractive index lower than the refractive index of the third transparent layer.

As compared with Example 3, it was possible to further reduce one-stage reflectivity in the touch sensor of Example 4 which had the laminate structure in which the sixth transparent layer having the refractive index which was higher than the refractive index of the base material on the substrate and was lower than the refractive index of the first transparent electrode, and the seventh transparent layer having the refractive index lower than the refractive index of the second electrode pattern were disposed.

Furthermore, the effect of reducing reflectivity was remarkable, the electrode-pattern-covering property was excellent, and the visibility of electrode patterns was further ameliorated in the touch sensor of Example 5 including the fourth transparent layer, the fifth transparent layer, the sixth transparent layer, and the seventh transparent layer.

—Production of Image Display Device (Touch Panel)—

The touch sensor produced in Example 1 was adhered to a liquid crystal display element manufactured by a method described in paragraphs 0097 to 0119 of JP2009-047936A, and furthermore, a front glass plate was adhered thereon, and thereby an image display device including an electrostatic capacitance-type input device as a component was produced by a known method.

In the same manner as described above, a touch panel which is an image display device was produced using the touch sensors of Examples 2 to 10 and Comparative Examples 1 and 2.

—Evaluation 2—

A sample image was displayed on the touch panel produced as described above, and observed.

As a result, the image displayed on the touch panel including the touch sensors produced in each of the examples was higher in contrast and sharper than the image displayed on the touch panel including the touch sensors of the comparative examples.

### EXPLANATION OF REFERENCES

10: temporary support
12: protective film or cover film
21: first transparent transfer layer
23: second transparent transfer layer
25: third transparent transfer layer
27: fourth transparent transfer layer
29: fifth transparent transfer layer
31: first transparent layer
33: second transparent layer
35: third transparent layer
37: fourth transparent layer
39: fifth transparent layer
41: sixth transparent layer
43: seventh transparent layer
51: first electrode (first electrode pattern)
53: second electrode (second electrode pattern)
60: base material
70: transparent adhesive layer
100, 200: transfer film
300, 400, 500, 600: touch sensor

What is claimed is:

1. A transfer material comprising:
a temporary support;
a second transparent transfer layer;
a third transparent transfer layer that is disposed on one surface of the second transparent transfer layer between the temporary support and the second transparent transfer layer and has a refractive index higher than a refractive index of the second transparent transfer layer; and
a first transparent transfer layer that is disposed on the other surface of the second transparent transfer layer and has a refractive index higher than the refractive index of the second transparent transfer layer.

2. The transfer material according to claim 1, wherein the temporary support is in contact with the third transparent transfer layer.

3. The transfer material according to claim 1, wherein a thickness of the second transparent transfer layer is 0.5 μm or more, and a thickness of each of the first transparent transfer layer and the third transparent transfer layer is 0.3 μm or less.

4. The transfer material according to claim 1, wherein a refractive index of each of the first transparent transfer layer and the third transparent transfer layer is 1.6 or more.

5. The transfer material according to claim 1, wherein the first transparent transfer layer and the third transparent transfer layer contain a metal oxide particle.

6. The transfer material according to claim 1, the transfer material further comprising:
a fourth transparent transfer layer that is disposed on a side of the first transparent transfer layer opposite to the surface on which the second transparent transfer layer is disposed, and has a refractive index lower than the refractive index of the first transparent transfer layer; and
a fifth transparent transfer layer that is disposed on a side of the third transparent transfer layer opposite to the surface on which the second transparent transfer layer is disposed, and has a refractive index lower than the refractive index of the third transparent transfer layer.

7. A touch sensor comprising:
a substrate that has a base material and a patterned first electrode;
a patterned second electrode;
a second transparent layer that is disposed between the first electrode and the second electrode and has a thickness of 0.5 μm or more and less than 25 μm;
a first transparent layer that is disposed between the first electrode and the second transparent layer and has a refractive index higher than a refractive index of the second transparent layer; and
a third transparent layer that is disposed between the second electrode and the second transparent layer and has a refractive index higher than a refractive index of the second transparent layer.

8. The touch sensor according to claim 7, wherein a thickness of the second transparent layer is 0.5 μm or more, and a thickness of each of the first transparent layer and the third transparent layer is 0.3 μm or less.

9. The touch sensor according to claim 7, wherein a refractive index of each of the first transparent layer and the third transparent layer is 1.6 or more.

10. The touch sensor according to claim 7, wherein the first transparent layer and the third transparent layer contain a metal oxide particle.

11. The touch sensor according to claim 7, the touch sensor further comprising:
a fourth transparent layer that is disposed on a side of the first transparent layer opposite to the side on which the second transparent layer is disposed, and has a refractive index lower than the refractive index of the first transparent layer; and
a fifth transparent layer that is disposed on a side of the third transparent layer opposite to the side on which the second transparent layer is disposed, and has a refractive index lower than the refractive index of the third transparent layer.

12. The touch sensor according to claim 11, wherein the first transparent layer, the second transparent layer, the third transparent layer, the fourth transparent layer, and the fifth transparent layer are transfer layers.

13. The touch sensor according to claim 7, the touch sensor further comprising a sixth transparent layer that is disposed between the base material and the first electrode and has a refractive index which is higher than a refractive index of the base material and is lower than a refractive index of the first electrode.

14. The touch sensor according to claim 7, the touch sensor further comprising a seventh transparent layer that is disposed on a side of the second electrode opposite to the side on which the second transparent layer is disposed, and has a refractive index lower than a refractive index of the second electrode.

15. A method for manufacturing a touch sensor by using the transfer material according to claim 1, the method comprising:
transferring the transfer material to form a second transparent layer on a first electrode;
transferring the transfer material between the first electrode and the second transparent layer to form a first transparent layer having a refractive index higher than a refractive index of the second transparent layer;
transferring the transfer material on a side of the second transparent layer opposite to the side having the first transparent layer to form a third transparent layer having a refractive index higher than the refractive index of the second transparent layer; and
disposing a second electrode on a side of the third transparent layer opposite to the side having the second transparent layer.

16. The method for manufacturing a touch sensor according to claim 15, the method further comprising:
transferring the transfer material on a side of the first transparent layer opposite to a side in contact with the second transparent layer to form a fourth transparent layer having a refractive index lower than the refractive index of the first transparent layer; and
transferring the transfer material on a side of the third transparent layer opposite to a side in contact with the second transparent layer to form a fifth transparent layer having a refractive index lower than a refractive index of the third transparent layer.

17. An image display device comprising the touch sensor according to claim 7.
